(19) United States
(12) Patent Application Publication
(10) Pub. No.: US 2023/0105706 A1
(43) Pub. Date: Apr. 6, 2023

(54) INFORMATION DISTRIBUTION HISTORY MANAGEMENT SYSTEM, INFORMATION DISTRIBUTION HISTORY MANAGEMENT METHOD, INFORMATION DISTRIBUTION HISTORY MANAGEMENT DEVICE AND PROGRAM

(71) Applicant: Nippon Telegraph and Telephone Corporation, Tokyo (JP)

(72) Inventors: Yurika SUGA, Musashino-shi, Tokyo (JP); Yasuhiko Yoshimura, Musashino-shi, Tokyo (JP); Takao Yamashita, Musashino-shi, Tokyo (JP); Yoshihiko Omori, Musashino-shi, Tokyo (JP)

(21) Appl. No.: 17/801,361

(22) PCT Filed: Jun. 8, 2020
(86) PCT No.: PCT/JP2020/022544

§ 371 Date: Aug. 22, 2022

(30) Foreign Application Priority Data
Feb. 26, 2020 (JP) PCT/JP2020/007785

(51) Int. Cl. G06Q 50/26; G06F 16/21

(52) U.S. Cl. CPC G06Q 50/265; G06F 16/219

(57) ABSTRACT

An information distribution history management system (10) includes a service user terminal (200) and a service provider server (300) that request an information distribution history management device (100) to make a record of provision in a case where personal information related to a user is provided to the service provider server (300). Also, the service provider server (300) requests the information distribution history management device (100) to make a record of receipt when the service provider server (300) receives the personal information. The information distribution history management device (100) stores records in response to requests and also searches the records. The records include identification information of the user of the service user terminal (200), identification information of the providing service provider server (300), and identification information of the receiving service provider server (300).

### TECHNICAL FIELD

The present invention relates to an information distribution history management system, an information distribution history management method, an information distribution history management device, and a program for managing personal information distributed between service providers.

### BACKGROUND ART

In order to use a service on the Internet, the user may be asked to present various personal information to the service provider in addition to a name, home address, email address, and the like. For example, a financial asset management service may ask the user for information such as owned financial assets and annual income. Also, a health management service may ask the user to transmit information such as height and weight information as well as a daily activity level and diet details to the service provider. A family budget management service may ask the user for a day-to-day purchase history.

In some cases, the personal information presented to the service provider is passed from the service provider to a different service provider. This includes cases where the personal information is passed to an associated (affiliated) service provider for providing the service, and cases where the personal information is passed as information for analyzing users of the service to improve the service.

In this way, personal information presented to a service provider is not limited to being used by the service provider and is presented to service providers affiliated with the service provider for reasons such as outsourcing and service quality improvement. From the perspective of protecting personal information, there is demand for a service user to be able to know which service providers the personal information presented by the service user is passed to (distributed to, provided to) and for what purpose.

According to the invention described in Patent Literature 1, because the service providers treated as a distribution destination of personal information are limited to service providers preregistered in a telecommunications service carrier (management server), the user can feel assured.

### CITATION LIST

### Patent Literature

Patent Literature 1: Japanese Patent Laid-Open No. 2009-245182

### SUMMARY OF THE INVENTION

### Technical Problem

According to the invention described in Patent Literature 1, the personal information passed to service providers is limited to only service providers preregistered with a telecommunications service carrier. On the other hand, the service provider indicates the transferees of presented (acquired) personal information in a personal information security policy, and the personal information presented to the service provider is passed to only trustworthy service providers.

However, after presenting personal information, the user is unable to grasp what types of personal information are provided to which service providers. Consequently, in the case where a personal information leak incident occurs in a certain service provider, the user is unable to grasp whether or not there is a possibility that the user's own personal information was leaked.

Also, for a service provider that provides a service the user is thinking about using, the user is unable to grasp what types of personal information the service provider passes to which other service providers. Consequently, the user is unable to determine whether or not to present personal information and use the service provided by the service provider server. For example, some users may accept having their name or home address passed to another service provider, but object to having their annual income passed to another service provider. However, with the invention described in Patent Literature 1, it is not possible to check whether or not specific types of personal information are passed on.

The present invention has been devised in the light of such context and addresses the problem of enabling a user to grasp the distribution destination of personal information distributed between service providers.

### Means for Solving the Problem

To address the above problem, an information distribution history management system according to the present invention comprises a service user terminal, a service provider server, and an information distribution history management device connected by a network, wherein the service user terminal requests the information distribution history management device to make a record of provision in a case where the service user terminal provides personal information related to a user of the service user terminal to the service provider server, the service provider server requests the information distribution history management device to make a record of receipt in a case where the service provider server receives the provision of the personal information, the information distribution history management device comprises a record creation unit that stores a record of provision in response to a request from the service user terminal and stores a record of receipt in response to a request from the service provider server, the service provider server requests the information distribution history management device to make a record of provision in a case where the service provider server provides the personal information to another service provider server, the other service provider server requests the information distribution history management device to make a record of receipt in a case where the other service provider server receives the provision of the personal information, and the record creation unit stores a record of provision in response to a request from the service provider server, and stores a record of receipt in response to a request from the other service provider server. The records include, in one case, identification information of the user of the service user terminal and identification information of the receiving service provider server or identification information of a service provider of the receiving service provider server, and in another case, identification information of the user of the service user terminal, identification information of the providing service provider server or identification information of a service provider of the providing service provider server, and identification information of the receiving other service provider server or identification information of a service provider of the receiving other service provider server. The information distribution history management device further comprises a record search unit that searches the records and returns a search result in response to a search request from the service user terminal or the service provider server.

### Effects of the Invention

According to the present invention, the user is enabled to grasp the distribution destination of personal information distributed between service providers.

### BRIEF DESCRIPTION OF DRAWINGS

FIG. 1 is a diagram for explaining the generation of distribution (provision/receipt) records for personal information in an information distribution history management system according to the present embodiment.

FIG. 2 is a diagram for explaining the searching of personal information distribution records in the information distribution history management system according to the present embodiment.

FIG. 3 is a function block diagram of an information distribution history management device according to the present embodiment.

FIG. 4 is a data structure diagram of a personal information database according to the present embodiment.

FIG. 5 is a data structure diagram of a record database according to the present embodiment.

FIG. 6 is a data structure diagram of an account database according to the present embodiment.

FIG. 7 is a function block diagram of a service user terminal according to the present embodiment.

FIG. 8 is a function block diagram of a service provider server according to the present embodiment.

FIG. 9 is a sequence diagram of an account registration process by the service user terminal according to the present embodiment.

FIG. 10 is a sequence diagram of an account registration process by the service provider server according to the present embodiment.

FIG. 11 is a sequence diagram (1) of a personal information provision process according to the present embodiment.

FIG. 12 is a sequence diagram (2) of a personal information provision process according to the present embodiment.

FIG. 13 is a sequence diagram (1) of a personal information distribution process between service providers according to the present embodiment.

FIG. 14 is a sequence diagram (2) of a personal information distribution process between service providers according to the present embodiment.

FIG. 15 is a sequence diagram of a search process requested by the service user terminal according to the present embodiment.

FIG. 16 is a sequence diagram of a search process requested by the service provider server according to the present embodiment.

FIG. 17 is a hardware configuration diagram illustrating an example of a computer that achieves the functions of the information distribution history management device according to the present embodiment.

FIG. 18 is a function block diagram of an information distribution history management device in the information distribution history management system according to Modifications 1 to 3 of the present embodiment.

FIG. 19 is a function block diagram of a service user terminal in the information distribution history management system according to Modifications 1 to 3 of the present embodiment.

FIG. 20 is a function block diagram of a service provider server in the information distribution history management system according to Modifications 1 to 3 of the present embodiment.

FIG. 21 is a sequence diagram of a personal information removal process by the information distribution history management system according to Modifications 1 to 3 of the present embodiment.

FIG. 22 is a sequence diagram of a process that makes the removed personal information of a user inaccessible in the personal information removal process by the information distribution history management system according to Modification 1 of the present embodiment.

FIG. 23 is a sequence diagram of a personal information removal process by the information distribution history management system according to Modification 2 of the present embodiment.

FIG. 24 is a sequence diagram of a personal information removal process by the information distribution history management system according to Modification 3 of the present embodiment.

### DESCRIPTION OF EMBODIMENTS

### Embodiment

### <<Overview of Information Distribution History Management Device>>

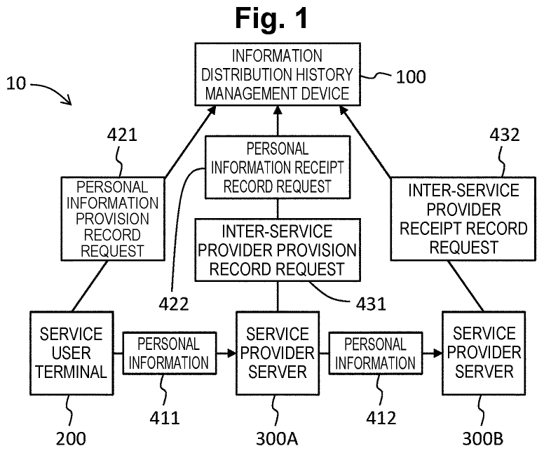

Hereinafter, an information distribution history management system including an information distribution history management device in a mode for carrying out (embodiment of) the present invention is described. FIG. 1 is a diagram for explaining the generation of distribution (provision/receipt) records for personal information 411 and 412 in the information distribution history management system 10 according to the present embodiment. An information distribution history management system 10 includes an information distribution history management device 100, a service user terminal 200, and service provider servers 300A and 300B. Note that the service provider servers 300A and 300B will be referred to as the service provider server(s) 300 when not being particularly distinguished.

The personal information 411 is personal information provided (presented) from the service user terminal 200 to the service provider server 300A. In FIG. 1, personal information is illustrated as being provided directly from the service user terminal 200 to the service provider server 300A, but in actuality, personal information is provided through the information distribution history management device 100. Specifically, the personal information 411 is transmitted from the service user terminal 200 to the information distribution history management device 100, and thereafter, the personal information 411 is transmitted from the information distribution history management device 100 to the service provider server 300A. In the following, the transmission of the personal information 411 from the service user terminal 200 to the information distribution history management device 100 is also referred to as the provision of the personal information 411. Also, the transmission of the personal information 411 from the information distribution history management device 100 to the service provider server 300A is also referred to as the receipt of the personal information 411.

The personal information 411 retained by the service provider server 300A is distributed to the service provider server 300B as the personal information 412 in some cases. In such cases, the personal information 412 likewise is distributed through the information distribution history management device 100. The transmission of the personal information 412 from the service provider server 300A to the information distribution history management device 100 is also referred to as the provision of the personal information 412. Also, the transmission of the personal information 412 from the information distribution history management device 100 to the service provider server 300B is also referred to as the receipt of the personal information 412.

When the personal information 411 of the user is transmitted from the service user terminal 200 used by the user to the service provider server 300A operated by the service provider, a history related to the transmission of the personal information 411 is stored in the information distribution history management device 100. Specifically, a personal information provision record request 421 that requests a record of the provision of personal information is transmitted from the service user terminal 200 to the information distribution history management device 100, and the information distribution history management device 100 makes a record of the provision. Also, a personal information receipt record request 422 that requests a record of the receipt of the personal information 411 is transmitted from the service provider server 300A to the information distribution history management device 100, and the information distribution history management device 100 makes a record of the receipt.

The case where the personal information 412 is transmitted between the service provider server 300A and the service provider server 300B is also similar. Specifically, an inter-service provider provision record request 431 that requests a record of the provision of personal information is transmitted from the service provider server 300A acting as the provision source to the information distribution history management device 100, and the information distribution history management device 100 makes a record of the provision. Also, an inter-service provider receipt record request 432 that requests a record of the receipt of the personal information 412 is transmitted from the service provider server 300B acting as the provision destination to the information distribution history management device 100, and the information distribution history management device 100 makes a record of the receipt.

The record includes the user (identification information of the user) and the type of personal information (personal information type) included in the personal information 411 and 412, the service provider servers 300A and 300B acting as the provision destination/provision source (identification information of the service provider servers 300), and the like. With this arrangement, in the case where a provision or a receipt of personal information occurs between the service user terminal 200 and a service provider server 300 or between the service provider servers 300, individual records of the provision and receipt remain in the information distribution history management device 100.

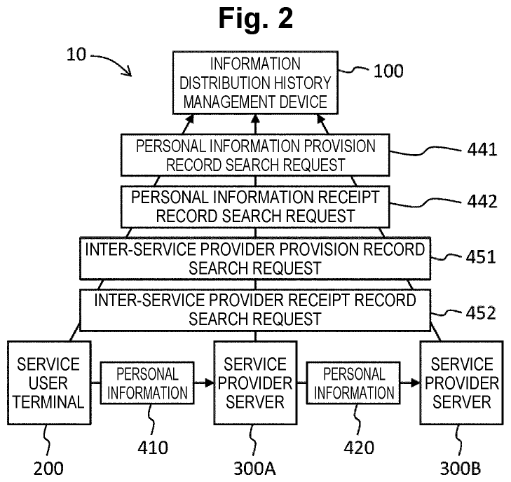

FIG. 2 is a diagram for explaining the searching of distribution records for the personal information 411 and 412 in the information distribution history management system 10 according to the present embodiment. The service user terminal 200 can transmit a personal information provision record search request 441 and a personal information receipt record search request 442 to the information distribution history management device 100, and thereby search for personal information that the user has provided to the service provider server 300. Also, the service user terminal 200 can transmit an inter-service provider provision record search request 451 and an inter-service provider receipt record search request 452 to the information distribution history management device 100, and thereby search for types of personal information and personal information about the user him- or herself that has been distributed between the service provider servers 300.

Note that although the above description makes a distinction between personal information records (provision and receipt from the service user terminal 200 to the service provider server 300) and inter-service provider records, a search for records without such a distinction may also be requested from the service user terminal 200 to the information distribution history management device 100. Additionally, the service user terminal 200 may also request a search for records without distinguishing between provision and receipt.

In this way, the service user terminal 200 requests the information distribution history management device 100 to search for records, thereby enabling the user to grasp which service providers have been provided with the user's own personal information. In addition, before providing the user's own personal information to a service provider, the user is able to grasp which other service providers would be provided with the user's own personal information if the user provides the personal information to the service provider.

The same also applies to a service provider, and by having the service provider server 300 transmit the inter-service provider provision record search request 451, the inter-service provider receipt record search request 452, the personal information provision record search request 441, and the personal information receipt record search request 442 to the information distribution history management device 100, the service provider is able to search for personal information that has been distributed between service provider servers 300 and grasp the distribution destinations of personal information provided by the service provider's own service.

Note that the service user terminal 200 and the service provider server 300 may also request searches for records without distinguishing between personal information records and inter-service provider records, and furthermore without distinguishing between provision and receipt.

<<Overview of Information Distribution History Management Device>>

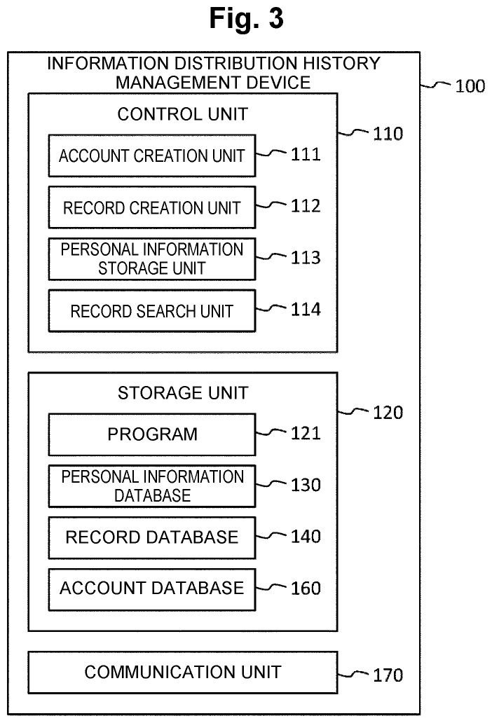

FIG. 3 is a function block diagram of the information distribution history management device 100 according to the present embodiment. The information distribution history management device 100 is provided with a control unit 110, a memory 120, and a communication unit 170. The communication unit 170 transmits and receives communication data with the service user terminal 200 and the service provider server 300.

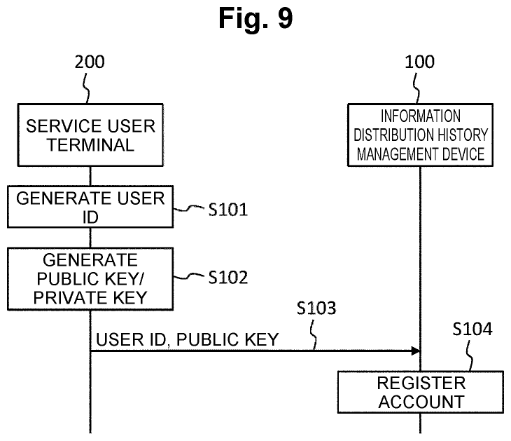

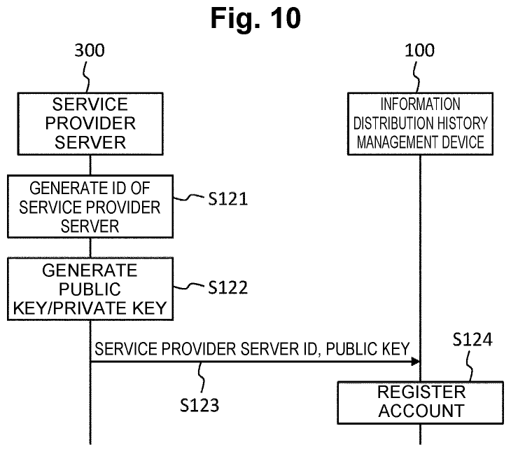

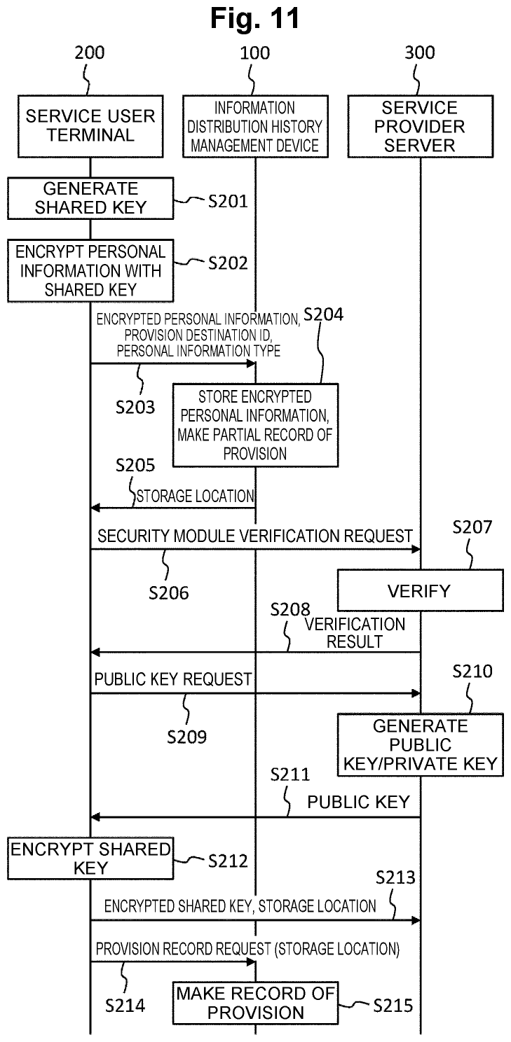

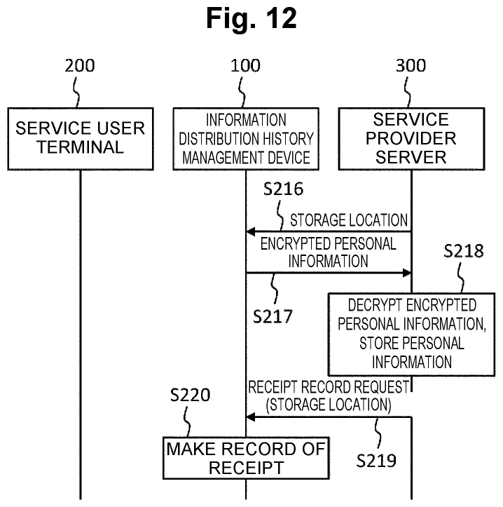

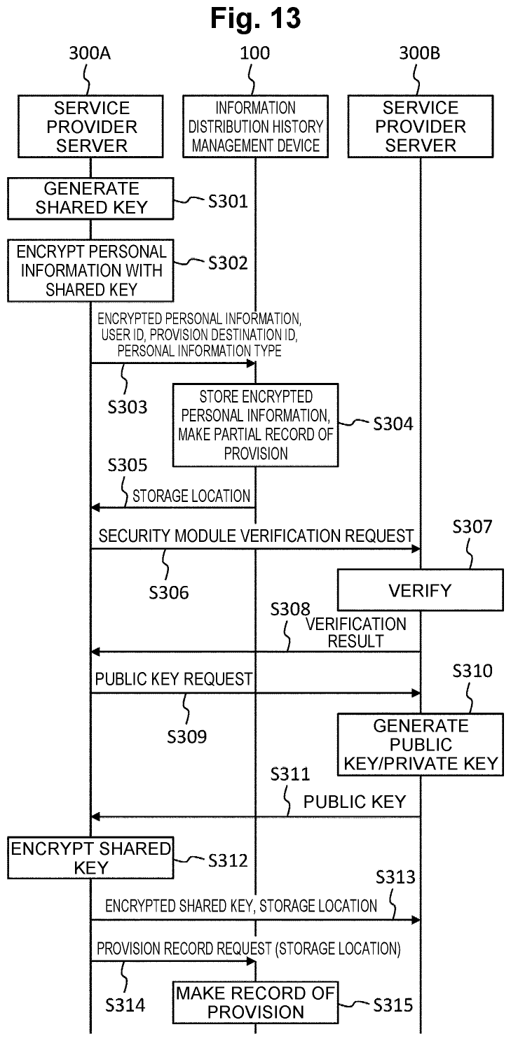

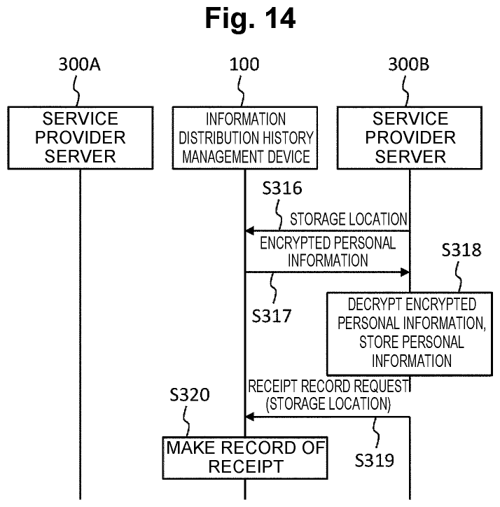

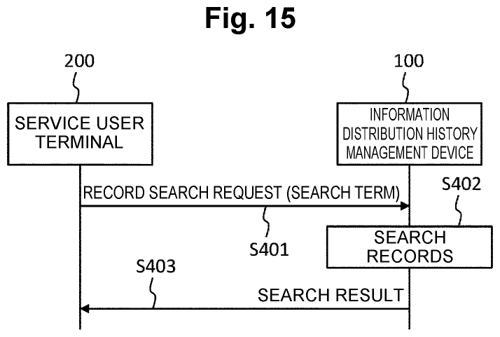

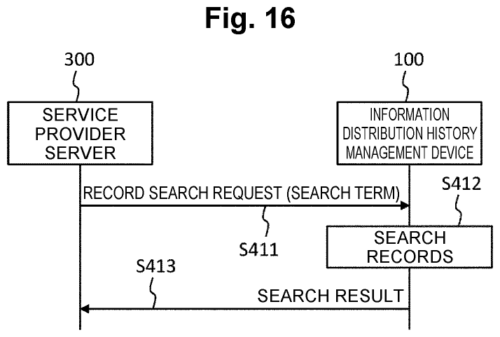

A program 121, a personal information database 130, a record database 140, and an account database 160 are stored in the memory 120. Procedures for an account registration process (see FIGS. 9 and 10 described later), a personal information provision process (see FIGS. 11 and 12 described later), an inter-service provider personal information distribution process (see FIGS. 13 and 14 described later), and a record search process (see FIGS. 15 and 16 described later), which are executed by a central processing unit (CPU) included in the control unit 110, are indicated in the program 121.

<<Overview of Information Distribution History Management Device: Personal Information Database>>

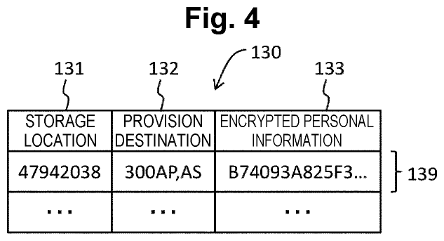

FIG. 4 is a data structure diagram of a personal information database 130 according to the present embodiment. Encrypted and received personal information from the service user terminal 200 or the service provider server 300 is stored in the personal information database 130. The personal information database 130 contains data in a table format for example, in which one row (record) indicates one piece of personal information, and includes columns (attributes) for a storage location 131, a provision destination 132, and encrypted personal information 133.

The storage location 131 indicates the storage location of personal information that has been encrypted, namely the encrypted personal information 133. The storage location 131 may also be considered to be identification information of the encrypted personal information 133. The provision destination 132 is identification information of the service provider server 300 acting as the provision destination of the encrypted personal information 133.

The storage location 131 of the encrypted personal information indicated in the record 139 is “47942038”, and the provision destination 132 is the service provider server 300A identified as “300AP,AS”. Note that in “300AP,AS”, “300AP” indicates the service provider who is the operator of the service provider server 300A, and “AS” indicates the service of the service provider server 300A. In the present embodiment, the identification information of the service provider server 300 is taken to be a combination of service provider identification information and service identification information.

The service provider server 300 can specify the storage location 131 to receive the encrypted personal information 133 from the information distribution history management device 100. At this time, the information distribution history management device 100 confirms that the destination service provider server 300 matches the provision destination 132 before transmitting.

<<Overview of Information Distribution History Management Device: Record Database>>

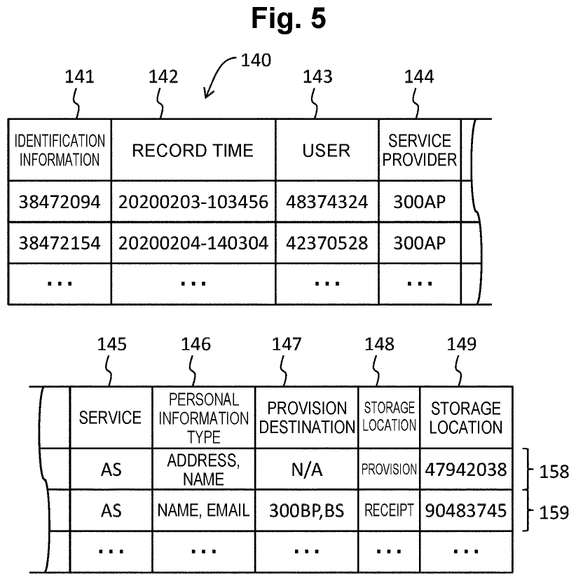

FIG. 5 is a data structure diagram of a record database 140 according to the present embodiment. Distribution records regarding personal information exchanged between the service user terminal 200 and the service provider server 300 are stored in the record database 140. The record database 140 contains data in a table format for example, in which one row (record) indicates a record of one provision or receipt of personal information, and includes columns (attributes) for identification information 141, a record time 142, a user 143, a service provider 144, a service 145, a personal information type 146, a provision destination 147, a record type 148, and a storage location 149.

The identification information 141 is identification information of the record.

The record time 142 indicates the date and time when the record was stored in the record database 140.

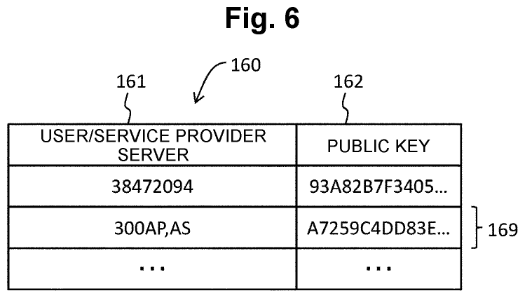

The user 143 indicates the user corresponding to the provided or received personal information, and indicates identification information of the user. The identification information corresponds to a user/service provider server 161 in the account database 160 (see FIG. 6 described later).

The service provider 144 and the service 145 indicate the service provider that received the provision of personal information and retains the personal information, and the service that uses the personal information. The operator of the service provider server 300 is the service provider 144, and the service of the service provider server 300 is the service 145. In the present embodiment, the service provider server 300 is identified by the combination of the service provider 144 and the service 145. In the case where a single service is provided by a plurality of service provider servers 300, the plurality of service provider servers 300 are collectively treated as a single service provider server 300.

The personal information type 146 indicates the type of personal information that was provided or received. The type may be a name, a home address, an email address, or a date of birth, for example.

The provision destination 147 indicates the service provider and the service to which the service provider server 300 provided the personal information. The service provider server 300 of the provision destination is identifiable by the service provider and the service.

The record type 148 indicates whether the record is a record of provision or a record of receipt.

The storage location 149 indicates the storage location 131 in the personal information database 130 (see FIG. 4) that was used at the time of the provision or receipt.

In the record indicated by the record 158, the record type 148 is provision, the identification information is “38472094”, and record time is 10:34:56, 3 Feb. 2020. The record is personal information about the user identified by “48374324”, and the type is home address and name. The personal information is used by the service 145 identified by “AS” and operated by the service provider 144 identified by “300AP”, and is provided through the storage location 149 identified by “47942038”.

According to the record indicated by the record 159, the personal information of the name and the email address of the user identified by “42370528” provided from the service provider server 300 of the service 145 identified by “AS” operated by the service provider 144 identified by “300AP” was received by the service provider server 300 identified by “300BP,BS” at the provision destination 147.

<<Overview of Information Distribution History Management Device: Account Database>>

FIG. 6 is a data structure diagram of the account database 160 according to the present embodiment. Authentication information for the service user terminal 200 and the service provider server 300 included in the information distribution history management system 10 is stored in the account database 160. The authentication information is registered in the account registration process (see FIGS. 9 and 10 described later).

The account database 160 contains data in a table format for example, in which one row (record) indicates one account, and includes columns (attributes) for a user/service provider server 161 and a public key 162.

The user/service provider server 161 is identification information of the user or service provider server 300.

The public key 162 is a public key for authenticating the service user terminal 200 used by the user or the service provider server 300 operated by the service provider.

The record 169 indicates that the public key of the service provider server 300A with the identification information “300AP,AS” is “A7259C4DD83E . . . ”.

<<Overview of Information Distribution History Management Device: Control Unit>>

Returning to FIG. 3, the control unit 110 is provided with an account creation unit 111, a record creation unit 112, a personal information storage unit 113, and a record search unit 114.

The account creation unit 111 performs the account registration process (see FIGS. 9 and 10 described later) in response to a request from the service user terminal 200 or the service provider server 300. After the account registration process, the public key 162 (see FIG. 6) to be used to authenticate the service user terminal 200 or the service provider server 300 in the personal information provision process (see FIGS. 11 and 12 described later), the inter-service provider personal information distribution process (see FIGS. 13 and 14 described later), and the record search process (see FIGS. 15 and 16 described later) is registered.

The record creation unit 112 receives the personal information provision record request 421, the personal information receipt record request 422, the inter-service provider provision record request 431, and the inter-service provider receipt record request 432 (see FIG. 1), and stores a record of the provision or receipt of personal information in the record database 140 (see FIG. 5).

The personal information storage unit 113 mediates the exchange of personal information between the service user terminal 200 and the service provider server 300. Specifically, in the provision and receipt of personal information from the service user terminal 200 to the service provider server 300, the personal information storage unit 113 stores encrypted personal information provided from the service user terminal 200 in the personal information database 130, and retrieves and transmits the encrypted personal information from the personal information database 130 to the receiving service provider server 300.

Also, in the provision and receipt of personal information between service provider servers 300, the personal information storage unit 113 stores encrypted personal information provided from the service provider server 300 acting as the provision source in the personal information database 130, and retrieves and transmits the encrypted personal information from the personal information database 130 to the receiving service provider server 300.

The record search unit 114 receives the personal information provision record search request 441, the personal information receipt record search request 442, the inter-service provider provision record search request 451, or the inter-service provider receipt record search request 452 (see FIG. 2) from the service user terminal 200 or the service provider server 300, searches the record database 140 (see FIG. 5), and returns a search result.

<<Configuration of Service User Terminal>>

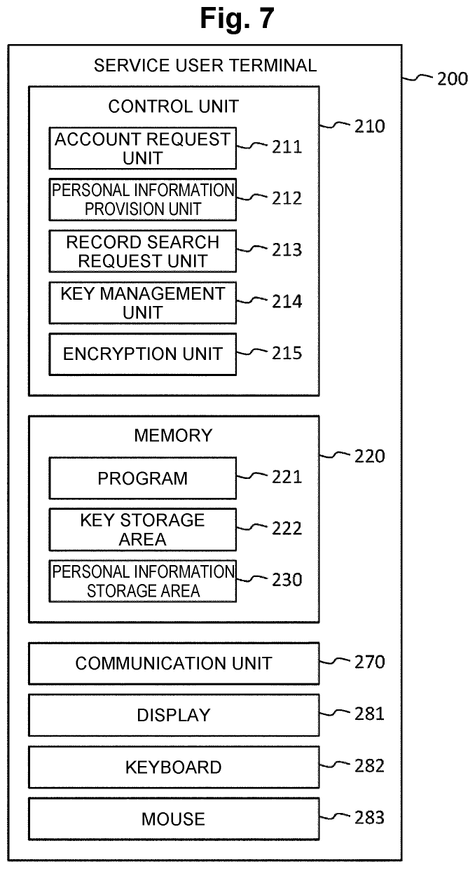

FIG. 7 is a function block diagram of the service user terminal 200 according to the present embodiment. The service user terminal 200 is provided with a control unit 210, a memory 220, a communication unit 270, a display 281, a keyboard 282, and a mouse 283. The communication unit 270 transmits and receives communication data exchanged with the information distribution history management device 100 and the service provider server 300.

The memory 220 stores a program 221, and is provided with a key storage area 222 and a personal information storage area 230.

Procedures for the account registration process (see FIG. 9 described later), the personal information provision process (see FIGS. 11 and 12 described later), and the record search process (see FIG. 15 described later), which are executed by a CPU included in the control unit 210, are indicated in the program 221.

In the key storage area 222, a private key and a public key for public-key cryptography used for authentication and encryption in the communication with the information distribution history management device 100 and the service provider server 300 are saved.

In the personal information storage area 230, personal information transmitted to the information distribution history management device 100 is saved.

The control unit 210 is provided with an account request unit 211, a personal information provision unit 212, a record search request unit 213, a key management unit 214, and an encryption unit 215.

The account request unit 211 requests the information distribution history management device 100 to register an account (see FIG. 9 described later).

To provide personal information to the service provider server 300, the personal information provision unit 212 transmits personal information to the information distribution history management device 100, and transmits the personal information provision record request 421 (see FIG. 1) to request a record of the provision of the personal information.

The record search request unit 213 transmits the personal information provision record search request 441, the personal information receipt record search request 442, the inter-service provider provision record search request 451, or the inter-service provider receipt record search request 452 (see FIG. 2) to the information distribution history management device 100 to request a record of providing personal information from the service user terminal 200 itself to the service provider server 300, a record of distribution between service provider servers 300, or a search for a type of personal information exchanged between service provider servers 300.

The key management unit 214 generates the private key and the public key for public-key cryptography used for authentication and encryption in the communication with the information distribution history management device 100 and the service provider server 300. Additionally, the key management unit 214 generates a shared key for shared-key cryptography used to encrypt personal information.

To provide personal information to the service provider server 300, the encryption unit 215 encrypts the personal information transmitted to the information distribution history management device 100. Moreover, the encryption unit 215 performs functions such as authentication, encryption, and decryption of communication with the information distribution history management device 100 and the service provider server 300.

<<Configuration of Service Provider Server>>

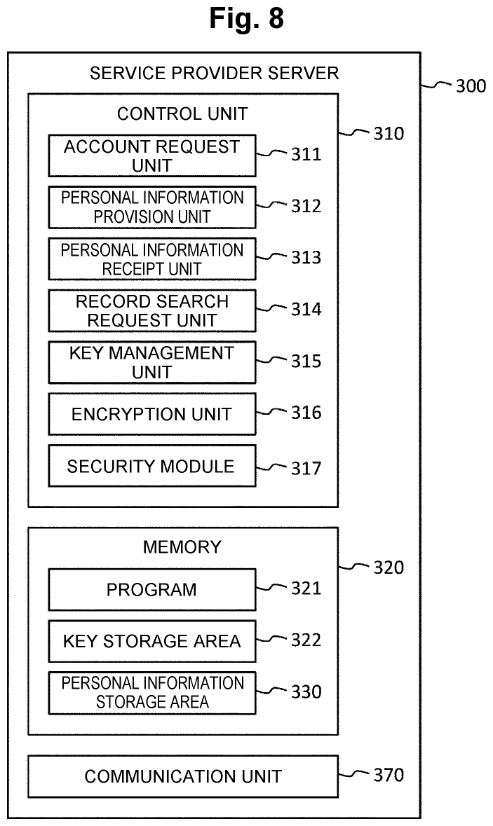

FIG. 8 is a function block diagram of the service provider server 300 according to the present embodiment. The service provider server 300 is provided with a control unit 310, a memory 320, and a communication unit 370. The communication unit 370 transmits and receives communication data exchanged with the information distribution history management device 100 and the service user terminal 200.

The memory 320 stores a program 321, and is provided with a key storage area 322 and a personal information storage area 330.

Procedures for the account registration process (see FIG. 10 described later), the personal information provision process (see FIGS. 11 and 12 described later), the inter-service provider personal information distribution process (see FIGS. 13 and 14 described later), and the record search process (see FIG. 16 described later), which are executed by a central processing unit (CPU) included in the control unit 310, are indicated in the program 321.

In the key storage area 322, a private key and a public key for public-key cryptography used for authentication and encryption in the communication with the information distribution history management device 100 and the service user terminal 200 are saved.

In the personal information storage area 330, personal information transmitted to the information distribution history management device 100 and personal information received from the information distribution history management device 100 are saved.

The control unit 310 is provided with an account request unit 311, a personal information provision unit 312, a personal information receipt unit 313, a record search request unit 314, a key management unit 315, an encryption unit 316, and a security module 317.

The account request unit 311 requests the information distribution history management device 100 to register an account (see FIG. 10 described later).

To provide personal information to another service provider server 300, the personal information provision unit 312 transmits personal information to the information distribution history management device 100, and transmits the inter-service provider provision record request 431 (see FIG. 1) to request a record of the provision of the personal information.

To receive personal information from the service user terminal 200, the personal information receipt unit 313 receives encrypted personal information from the information distribution history management device 100, and transmits the personal information receipt record request 422 to request a record of the receipt of the personal information. Also, to receive personal information from another service provider server 300, the personal information receipt unit 313 receives encrypted personal information from the information distribution history management device 100, and transmits the inter-service provider receipt record request 432 to request a record of the receipt of the personal information.

The record search request unit 314 transmits the personal information provision record search request 441, the personal information receipt record search request 442, the inter-service provider provision record search request 451, or the inter-service provider receipt record search request 452 (see FIG. 2) to the information distribution history management device 100 to request a record of acquiring personal information from the service user terminal 200, a record of the distribution of personal provided by the service provider server 300 itself to another service provider server 300, or a search for a type of personal information exchanged between service provider servers 300.

The key management unit 315 generates the private key and the public key for public-key cryptography used for authentication and encryption in the communication with the information distribution history management device 100 and the service user terminal 200. Additionally, the key management unit 315 generates a shared key for shared-key cryptography used to encrypt personal information.

To provide personal information to the service provider server 300, the encryption unit 316 encrypts the personal information transmitted to the information distribution history management device 100. The encryption unit 316 also decrypts encrypted personal information received from the service provider server 300. Moreover, the encryption unit 316 performs functions such as authentication, encryption, and decryption of communication with the information distribution history management device 100 and the service user terminal 200.

The security module 317 enforces the handling of received personal information according to the security policy of the service provider and the service. In addition, the security module 317 replies to queries from the service user terminal 200 and the service provider server 300 about whether or not such enforcement is possible.

Examples of the handling of personal information include storing personal information in a memory medium other than a main memory such as a hard disk, and encrypting personal information in the case of transmitting the personal information as communication data. Note that the function by which the security module 317 replies to a query about whether or not the handling of personal information is enforced according to a security policy is referred to as an attestation function.

Hereinafter, the sequence diagrams in FIGS. 9 to 16 will be referenced to describe the account registration process, the process of providing personal information from the service user terminal 200 to the service provider server 300, the process of distributing personal information between service providers (service provider servers 300), and the record search process. Note that communication between the information distribution history management device 100, the service user terminal 200, and the service provider servers 300 is assumed to be protected appropriately. For example, in the account registration process (see FIGS. 9 and 10 described later), it is assumed that the service user terminal 200 and the service provider server 300 use the public key of the information distribution history management device 100 to authenticate the information distribution history management device 100, and that the communication data is encrypted. Also, in the personal information provision process and the inter-service provider personal information distribution process, it is assumed that the public keys of the information distribution history management device 100, the service user terminal 200, and the service provider servers 300 are used for bidirectional authentication of communication, and that the communication data is encrypted.

<<Account Registration Process: Service User Terminal>>

FIG. 9 is a sequence diagram of an account registration process by the service user terminal 200 according to the present embodiment. FIG. 9 will be referenced to describe the process of registering the identification information of the user and the public key of the service user terminal 200 in the information distribution history management device 100.

In step S101, the account request unit 211 of the service user terminal 200 generates identification information of the user (designated the “user ID (IDentifier)” in FIG. 9). The account request unit 211 generates a random number as the identification information of the user, for example.

In step S102, the key management unit 214 of the service user terminal 200 generates and stores a public/private key pair for public-key cryptography in the key storage area 222.

In step S103, the account request unit 211 transmits the identification information of the user (designated the “user ID” in FIG. 9) generated in step S101 and the public key generated in step S102 to the information distribution history management device 100.

In step S104, the account creation unit 111 of the information distribution history management device 100 creates and registers an account. Specifically, the account creation unit 111 confirms that the received identification information of the user is not registered in user/service provider server 161 of the account database 160 (see FIG. 6). If the identification information is already registered, the account creation unit 111 reports an error to the service user terminal 200 and ends the account registration process.

Hereinafter, the description will continue under the assumption that the identification information is not registered. The account creation unit 111 adds a record to the account database 160. Next, the account creation unit 111 stores the received identification information of the user in the user/service provider server 161 of the added record, and stores the public key received in step S103 in the public key 162.

<<Account Registration Process: Service Provider Server>>

FIG. 10 is a sequence diagram of the account registration process by the service provider server 300 according to the present embodiment. The account registration process by the service provider server 300 is similar to the account registration process by the service user terminal 200 illustrated in FIG. 9, and steps S121 to S124 correspond to steps S101 to S104, respectively.

<<Personal Information Provision Process>>

FIG. 11 is a sequence diagram (1) of the personal information provision process according to the present embodiment. FIG. 12 is a sequence diagram (2) of the personal information provision process according to the present embodiment. FIGS. 11 and 12 will be referenced to describe the process of providing personal information from the service user terminal 200 to the service provider server 300 through the information distribution history management device 100.

In step S201, the key management unit 214 of the service user terminal 200 generates a shared key (private key) for shared-key cryptography for encrypting personal information.

In step S202, the encryption unit 215 of the service user terminal 200 uses the shared key generated in step S201 to encrypt the personal information to be provided to the service provider server 300 and the identification information of the user. Note that in the following, the personal information and the identification information of the user are also collectively referred to as the personal information.

In step S203, the personal information provision unit 212 of the service user terminal 200 transmits the personal information encrypted in step S202 (hereinafter also referred to as the encrypted personal information), the identification information of the service provider server 300 acting as the provision destination (designated the “provision destination ID” in FIG. 11), and the personal information type to the information distribution history management device 100.

In step S204, the personal information storage unit 113 of the information distribution history management device 100 stores the received encrypted personal information in the personal information database 130. Also, the record creation unit 112 of the information distribution history management device 100 makes a partial record of provision in the record database 140. A detailed description follows.

The personal information storage unit 113 adds a record to the personal information database 130 (see FIG. 4) and stores the encrypted personal information received in step S203 in the encrypted personal information 133 of the record. Next, the personal information storage unit 113 stores the received identification information of the service provider server 300 acting as the provision destination (designated the “provision destination ID” in FIG. 11) in the provision destination 132 of the record. The personal information storage unit 113 also generates a random number as the storage location, and stores the generated random number in the storage location 131 of the record.

Next, the record creation unit 112 adds a record to the record database 140 (see FIG. 5), and stores the storage location generated above in the storage location 149 of the record. Next, the record creation unit 112 generates and stores a random number in the identification information 141, stores the personal information type received in step S203 in the personal information type 146, and stores the identification information of the user of the service user terminal 200 in the user 143 of the record. Additionally, from the identification information of the service provider server 300 acting as the provision destination (designated the “provision destination ID” in FIG. 11) received in step S203, the record creation unit 112 stores the identification information of the service provider in the service provider 144 and stores the identification information of the service in the service 145 of the record. The record creation unit 112 stores “N/A (not applicable)” in the provision destination 147 and “provision” in the record type 148 of the record. Note that the record time 142 is not updated (but is updated in step S215 described later).

In step S205, the personal information storage unit 113 transmits the storage location generated in step S204 to the service user terminal 200.

In step S206, the personal information provision unit 212 requests the service provider server 300 to verify the security module 317. Specifically, the personal information provision unit 212 queries whether or not the handling of personal information is enforced according to a security policy.

In step S207, the security module 317 of the service provider server 300 verifies whether or not the handling of personal information is enforced according to a security policy in the service provider server 300.

In step S208, the security module 317 transmits a result of the verification in step S207 to the service user terminal 200 (attestation function). If the received verification result is that the handling of personal information is not enforced, the personal information provision unit 212 of the service user terminal 200 aborts the personal information provision process. Hereinafter, the description will continue under the assumption that the handling of personal information is enforced.

In step S209, the personal information provision unit 212 requests the service provider server 300 for a public key. The public key is the key used to encrypt the shared key (see step S201), which is used to encrypt the personal information to be provided to the service provider server 300.

In step S210, the key management unit 315 of the service provider server 300 generates a public/private key pair for public-key cryptography.

In step S211, the key management unit 315 transmits the public key generated in step S210 to the service user terminal 200.

In step S212, the encryption unit 215 of the service user terminal 200 encrypts the shared key generated in step S201 with the public key received in step S211.

In step S213, the personal information provision unit 212 transmits the encrypted shared key and the storage location to the service provider server 300.

In step S214, the personal information provision unit 212 transmits the storage location and requests the information distribution history management device 100 to make a record of the provision of the personal information.

In step S215, the record creation unit 112 of the information distribution history management device 100 searches the record database 140 (see FIG. 5) for a record containing the storage location received in step S214 as the storage location 149 and “provision” as the record type 148, and specifies the record that was updated in step S204. The record creation unit 112 updates the record time 142 of the specified record to the current time.

Moving to FIG. 12, in step S216, the personal information receipt unit 313 of the service provider server 300 transmits the storage location received in step S213 and requests the information distribution history management device 100 for the encrypted personal information.

In step S217, the personal information storage unit 113 transmits the encrypted personal information to the service provider server 300. Specifically, the personal information storage unit 113 searches the personal information database 130 (see FIG. 4) for a record containing a storage location 131 that matches the received storage location. Next, the personal information storage unit 113 confirms that the provision destination 132 of the record in the search result matches is in agreement with the service provider server 300 that requested the encrypted personal information. In the case of non-agreement, the personal information storage unit 113 transmits an error to the service provider server 300, whereas in the case of agreement, the personal information storage unit 113 transmits the encrypted personal information 133 of the record in the search result. In the case where an error is received, the personal information receipt unit 313 of the service provider server 300 aborts the personal information provision process.

In step S218, the encryption unit 316 of the service provider server 300 decrypts the encrypted personal information and stores the personal information and the identification information of the user obtained as the decryption result in the personal information storage area 330. Specifically, the encryption unit 316 decrypts the encrypted shared key received in step S213 with the private key generated in step S210 to acquire the shared key. Next, the encryption unit 316 uses the shared key to decrypt the encrypted personal information received in step S217 to thereby obtain and store the personal information and the identification information of the user in the personal information storage area 330.

In step S219, the personal information receipt unit 313 transmits the storage location and requests the information distribution history management device 100 to make a record of the receipt of the personal information.

In step S220, the record creation unit 112 of the information distribution history management device 100 creates a record of the receipt. Specifically, the record creation unit 112 searches the record database 140 (see FIG. 5) for a record containing a storage location 149 that matches the received storage location. The search result is the record that was updated in steps S204 and S215. Next, the record creation unit 112 adds a record to the record database 140 and updates the user 143, the service provider 144, the service 145, the personal information type 146, the provision destination 147, and the storage location 149 of the added record with the user 143, the service provider 144, the service 145, the personal information type 146, the provision destination 147, and the storage location 149 of the record in the search result, respectively. Subsequently, the record creation unit 112 updates the identification information 141 of the added record to newly generated identification information, updates the record time 142 to the current time, and updates the record type 148 to “receipt”.

With the above, the generation of a receipt record ends, but thereafter the personal information storage unit 113 may also remove the record of the encrypted personal information transmitted in step S217 from the personal information database 130.

<<Personal Information Distribution Process Between Service Providers>>

FIG. 13 is a sequence diagram (1) of the personal information distribution process between service providers according to the present embodiment. FIG. 14 is a sequence diagram (2) of the personal information distribution process between service providers according to the present embodiment. The personal information distribution process between service providers is similar to the personal information provision process illustrated in FIGS. 11 and 12 except for the handling of the provision destination 147 in the record database 140 (see FIG. 5). In the following, steps S303 to S304 and step S320 will be described as processes related to the record database 140.

In step S303, the personal information provision unit 312 of the service provider server 300A transmits the personal information encrypted in step S302 (including the identification information of the user), the identification information of the user associated with the personal information (the identification information of the user that was encrypted together with the personal information in step S302, designated the “user ID” in FIG. 13), the identification information of the service provider server 300 acting as the provision destination (designated the “provision destination ID” in FIG. 13), and the type of personal information (personal information type) to the information distribution history management device 100.

Compared to step S203, the identification information of the user is additionally transmitted to the information distribution history management device 100.

In step S304, the personal information storage unit 113 of the information distribution history management device 100 stores the received encrypted personal information in the personal information database 130. Also, the record creation unit 112 of the information distribution history management device 100 makes a partial record of provision in the record database 140. The process of updating the personal information database 130 is similar to step S204 (see FIG. 11).

The record creation unit 112 adds a record to the record database 140 (see FIG. 5), and stores the storage location added to the personal information database 130 in the storage location 149 of the record. Next, the record creation unit 112 generates and stores a random number in the identification information 141, stores the personal information type received in step S303 in the personal information type 146, and stores the identification information of the user received in step S303 in the user 143 of the record. Additionally, the record creation unit 112 stores the received identification information of the service provider server 300 acting as the provision destination in the provision destination 147, and from the identification information of the service provider server 300A acting as the provision source in step S303, stores the identification information of the service provider in the service provider 144 and stores the identification information of the service in the service 145 of the record. The record creation unit 112 stores “provision” in the record type 148. Note that the record time 142 is not updated (but is updated in step S315 described later). Note that step S315 is similar to step S215 (see FIG. 11), and the updated record is the record that was updated in step S304.

In step S204, the provision destination 147 is “N/A”, but in step S304 is the service provider server 300B treated as the provision destination by the service provider server 300A.

Next, step S320 will be described with regard to the difference between FIG. 11 and FIG. 12. Step S320 is similar to step S220. However, whereas the provision destination 147 of the record of receipt added in step S220 is “N/A”, the provision destination 147 is the service provider server 300B in step S320.

<<Record Search Process: Service User Terminal>>

FIG. 15 is a sequence diagram of a search process requested by the service user terminal 200 according to the present embodiment.

In step S401, the record search request unit 213 of the service user terminal 200 transmits a search term and requests the information distribution history management device 100 to search the records. Details about the search term will be described later.

In step S402, the record search unit 114 of the information distribution history management device 100 searches the record database 140 according to the received search term. Details about the search according to the search term will be described later.

In step S403, the record search unit 114 of the information distribution history management device 100 transmits a result of the search in step S402 to the service user terminal 200.

Hereinafter, the search term and the search according to the search term will be described. The search term may be a user, a user and a service provider server, or a service provider server.

In the case where the search term is a user (identification information of a user), the record search unit 114 confirms that the relevant user is the user of the service user terminal 200 that requested the search, and then searches for records of the provision and receipt of personal information about the relevant user. Specifically, after confirming that the user in the search term is the user of the service user terminal 200 that requested the search, the record search unit 114 searches the record database 140 (see FIG. 5) for records containing a user 143 that matches the user in the search term. The record search unit 114 transmits the search result to the service user terminal 200 with the identification information 141 and the storage location 149 excluded.

In the case where the search term is a user and a service provider server (identification information of a service provider and identification information of a service), the record search unit 114 confirms that the user in the search term is the user of the service user terminal 200 that requested the search, and then searches for records of the relevant service provider server providing or receiving personal information about the relevant user. Specifically, after confirming that the user in the search term is the user of the service user terminal 200 that requested the search, the record search unit 114 searches the record database 140 (see FIG. 5) for records containing a user 143 that matches the user in the search term as well as a service provider 144 and a service 145 that match the service provider server in the search term, and also for records containing a user 143 that matches the user in the search term as well as a provision destination 147 that matches the service provider server in the search term. The record search unit 114 transmits the search result to the service user terminal 200 with the identification information 141 and the storage location 149 excluded.

The service provider server in the search term may also be a service provider. Specifically, the record search unit 114 searches the record database 140 (see FIG. 5) for records containing a user 143 that matches the user in the search term as well as a service provider 144 that matches the service provider in the search term, and also for records containing a user 143 that matches the user in the search term as well as a provision destination 147 that matches a service provider server operated by the service provider in the search term (that provision destination 147 includes the identification information of the service provider).

In the case where the search term is a service provider server, the record search unit 114 searches for records of the provision and receipt of personal information by the service provider server. Specifically, the record search unit 114 searches the record database 140 for records containing a service provider 144 and a service 145 that match the service provider server in the search term, and also for records containing a provision destination 147 that matches the service provider server in the search term. The record search unit 114 transmits the search result to the service user terminal 200 with the identification information 141, the user 143, and the storage location 149 excluded. The service provider server in the search term may also be a service provider.

Note that the record search unit 114 may further exclude the record time 142 and the record type 148, and transmit the remaining attributes of the service provider 144, the service 145, the personal information type 146, and the provision destination 147 to the service user terminal 200. At this time, the record search unit 114 may also transmit records containing the same service provider 144, service 145, personal information type 146, and provision destination 147 collectively as a single record.

The search term may also be another term corresponding to an attribute in the record database 140. For example, the search term may also be a user and a record period. In this case, after confirming that the user in the search term is the user of the service user terminal 200 that requested the search, the record search unit 114 searches for records of the provision and receipt of personal information about the relevant user and for which the record time 142 is included in the record period of the search term.

In the case where the search term is a personal information type, the record search unit 114 searches for records of the provision and receipt of the relevant personal information type. Specifically, the record search unit 114 searches the record database 140 (see FIG. 5) for records containing a personal information type 146 that matches the personal information type in the search term. The record search unit 114 transmits the search result to the service user terminal 200 with the identification information 141, the user 143, and the storage location 149 excluded.

Note that the record search unit 114 may further exclude the record time 142 and the record type 148, and transmit the remaining attributes of the service provider 144, the service 145, the personal information type 146, and the provision destination 147 to the service user terminal 200. At this time, the record search unit 114 may also transmit records containing the same service provider 144, service 145, personal information type 146, and provision destination 147 collectively as a single record.

The type of record to search for may also be added as an optional search term. Types of records include records of provision from the service user terminal 200 to the service provider server 300, records of receipt from the service user terminal 200 to the service provider server 300, records of provision between service provider servers 300, and records of receipt between service provider servers 300. A search request for records of provision from the service user terminal 200 to the service provider server 300 corresponds to the personal information provision record search request 441 (see FIG. 2). A search request for records of receipt from the service user terminal 200 to the service provider server 300 corresponds to the personal information receipt record search request 442. A search request for records of provision between service provider servers 300 corresponds to the inter-service provider provision record search request 451. A search request for records of receipt between service provider servers 300 corresponds to the inter-service provider receipt record search request 452.

In the case where a type of record is added to the search request, the record search unit 114 limits the search of the record database 140 (see FIG. 5) to the relevant type. The distinction between provision/receipt can be made according to the record type 148. Records of provision or receipt from the service user terminal 200 to the service provider server 300 can be determined if the provision destination 147 is N/A. Note that in the case where the search request does not specify the type of record, all records are searched as described above.

The record search unit 114 may also be configured not to search for records regarding users other than the user of the service user terminal 200. In the communication between the service user terminal 200 and the information distribution history management device 100, the other end of the communication is authenticated, and the information distribution history management device 100 identifies the user of the service user terminal 200 on the other end of the communication. The record search unit 114 may also be configured not to perform searches related to users other than the identified user. For example, the record search unit 114 rejects searches that include a user other than identified user in the search request.

Also, in the case where a user is not included in the search term, the record search unit 114 may return a search result to the service user terminal 200 with the user 143 excluded from the search result.

With this arrangement, the information distribution history management device 100 is capable of performing searches while also protecting user privacy.

<<Record Search Process: Service Provider Server>>

FIG. 16 is a sequence diagram of a search process requested by the service provider server 300 according to the present embodiment.

In step S411, the record search request unit 314 of the service provider server 300 transmits a search term and requests the information distribution history management device 100 to search the records. Details about the search term will be described later.

In step S412, the record search unit 114 of the information distribution history management device 100 searches the record database 140 according to the received search term. Details about the search according to the search term will be described later.

In step S413, the record search unit 114 of the information distribution history management device 100 transmits a result of the search in step S402 to the service provider server 300.

Hereinafter, the search term and the search according to the search term will be described. The search term may be a service provider server, a personal information type, or a service provider server and a user.

In the case where the search term is a service provider server, the record search unit 114 searches for records of provision or receipt involving the service provider server. Specifically, the record search unit 114 searches the record database 140 for records containing a service provider 144 and a service 145 that match the service provider server in the search term, and also for records containing a provision destination 147 that matches the service provider server in the search term. The record search unit 114 transmits the search result to the service provider server 300 with the identification information 141, the user 143, and the storage location 149 excluded. The service provider server in the search term may also be a service provider.

In the case where the search term is a personal information type, the record search unit 114 searches for records of the provision and receipt of the relevant personal information type. Specifically, the record search unit 114 searches the record database 140 (see FIG. 5) for records containing a personal information type 146 that matches the personal information type in the search term. The record search unit 114 transmits the search result to the service provider server 300 with the identification information 141, the user 143, and the storage location 149 excluded.

Note that the record search unit 114 may further exclude the record time 142 and the record type 148, and transmit the remaining attributes of the service provider 144, the service 145, the personal information type 146, and the provision destination 147 to the service provider server 300. At this time, the record search unit 114 may also transmit records containing the same service provider 144, service 145, personal information type 146, and provision destination 147 collectively as a single record.

In the case where the search term is a service provider server and a user, the record search unit 114 confirms that the relevant service provider server is the service provider server 300 that requested the search, and then searches for the distribution destination and the distribution source as the distribution channel of the relevant user. First, the search for the distribution destination will be described. The record search unit 114 searches the record database 140 for records which contain a service provider 144 and a service 145 that match the service provider server in the search term, which contain a user 143 that matches the user in the search term, and for which the record type 148 is receipt. The provision destination 147 of the record(s) in the search result is a first-order distribution destination for the relevant user. Also, the personal information type 146 of the record(s) in the search result is a first-order personal information type. The first-order distribution destination may or may not be plural. Also, the first-order personal information type may be different depending on the first-order distribution destination.

Next, the record search unit 114 searches for records for which the service provider 144 and the service 145 are the first-order distribution destination, the user 143 is the user in the search term, the record type 148 is receipt, and the personal information type 146 is included in the first-order personal information type of the relevant first-order distribution destination. In the record(s) in the search result, the provision destination 147 is a second-order distribution destination and the personal information type 146 is a second-order personal information type. The record search unit 114 repeats the search for the third order, fourth order, fifth order, and so on until there are no more distribution destinations.

Following the search for the distribution destination, the search for the distribution source will be described. The record search unit 114 searches the record database 140 for records which contain a provision destination 147 that matches the service provider server in the search term and for which the user 143 is the user in the search term and the record type 148 is receipt, and also for records for which the service provider 144 and the service 145 are the service provider server in the search term, the provision destination 147 is “N/A”, the user 143 is the user in the search term, and the record type 148 is receipt. The service provider 144 and the service 145 of the record(s) in the search result indicate a first-order distribution source for the relevant user. Also, the personal information type 146 of the record(s) in the search result is a first-order personal information type. The first-order distribution source may or may not be plural. Also, the first-order personal information type may be different depending on the first-order distribution source.

Next, the record search unit 114 searches for records for which the provision destination 147 is the first-order distribution source, the user 143 is the user in the search term, the record type 148 is receipt, and the personal information type 146 includes the first-order personal information type of the relevant first-order distribution source, and also for records for which the service provider 144 and the service 145 are the first-order flow source, the provision destination 147 is “N/A”, the user 143 is the user in the search term, the record type 148 is receipt, and the personal information type 146 includes the first-order personal information type of the relevant first-order distribution source. The service provider 144 and the service 145 of the record(s) in the search result indicate a second-order distribution source, and the personal information type 146 is a second-order personal information type. The record search unit 114 repeats the search for the third order, fourth order, fifth order, and so on until there are no more distribution sources. According to the above, it is possible to search for the distribution channel. The service provider server in the search term may also be a service provider.

Note that even in the case where the search term is a user, the record search unit 114 may also search for the distribution destination and the distribution source as the distribution channel of the relevant user described above. In this case, the service provider server given in the search term is treated as the requesting service provider server.

The search term may also be another term corresponding to an attribute in the record database 140. For example, the search term may also be a service provider server and a record period. In this case, the record search unit 114 searches for records for which the service provider server 300 is the service provider 144 and the service 145 or the provision destination 147, and the record time 142 is included in the record period of the search term.

Also, a service provider may be used instead of a service provider server. A search for a service provider is a search for the provision and receipt of personal information involving all service provider servers 300 operated by the relevant service provider.

The type of record to search for is similar to the search request from the service user terminal 200 (see FIG. 15).

In the case where the search term includes a user, the record search unit 114 may be configured not to search for records related to the personal information of the user other than the personal information provided or received by the service provider server 300. In the communication between the service provider server 300 and the information distribution history management device 100, the other end of the communication is authenticated, and the information distribution history management device 100 identifies the service provider server 300 on the other end of the communication. The record search unit 114 may also be configured not to perform searches related to users other than those provided or received by the identified service provider server 300. For example, when a search request including a user is received, the record search unit 114 limits the requested search of the record database 140 to records for which the user 143 includes the relevant user and the service provider 144 and the service 145 or the provision destination 147 includes the requesting service provider server 300.

Also, in the case where a user is not included in the search term, the record search unit 114 may return a search result to the service provider server 300 with the user 143 excluded from the search result.

With this arrangement, the information distribution history management device 100 is capable of performing searches while also protecting user privacy.

<<Features of Information Distribution History Management System>>

In the information distribution history management system 10 (see FIG. 1), in the case where personal information is provided from the service user terminal 200 to the service provider server 300A, encrypted personal information is transmitted from the service user terminal 200 to the information distribution history management device 100, and then transmitted from the information distribution history management device 100 to the service provider server 300A. When the encrypted personal information is transmitted from the service user terminal 200 to the information distribution history management device 100, a record of the provision of the personal information is made in the record database 140 according to a request by the service user terminal 200. Also, when the encrypted personal information is transmitted from the information distribution history management device 100 to the service provider server 300A, a record of the receipt of the personal information is made in the record database 140 according to a request by the service provider server 300A.

In the case where personal information is provided from the service provider server 300A to the service provider server 300B, encrypted personal information is transmitted from the service provider server 300A to the information distribution history management device 100, and then transmitted from the information distribution history management device 100 to the service provider server 300B. When the encrypted personal information is transmitted from the service provider server 300A to the information distribution history management device 100, a record of the provision of the personal information is made in the record database 140 according to a request by the service provider server 300A. Also, when the encrypted personal information is transmitted from the information distribution history management device 100 to the service provider server 300B, a record of the receipt of the personal information is made in the record database 140 according to a request by the service provider server 300B.

The records include information such as the user associated with the personal information, the service provider (service provider and service) acting as the provision destination (recipient) or the provision source (provider), and the type of personal information.

The service user terminal 200 and the service provider server 300 can request the information distribution history management device 100 to search for records. The user is able to grasp which service providers have been provided with the user's own personal information. In addition, before providing the user's own personal information to a service provider, the user is able to grasp which other service providers would be provided with the user's own personal information if the user provides the personal information to the service provider.

The service provider server 300 can grasp the service provider server 300 specified in a search request or the type of the personal information retained by the service provider. Additionally, the service provider server 300 can grasp the distribution destination of personal information provided by the service provider server 300 itself, and the distribution source of personal information received by the service provider server 300 itself. The service provider is able to confirm whether the personal information provided by the service provider itself has been distributed to an unintended service provider. Additionally, the service provider is able to confirm whether the personal information received by the service provider itself was distributed from an unauthorized service provider.

<<Modification: Record Request Parameter>>

In the embodiment described above, the parameter of the provision record request (see step S214 illustrated in FIG. 11 and step S314 illustrated in FIG. 13) and the receipt record request (see step S219 illustrated in FIG. 12 and step S319 illustrated in FIG. 14) is the storage location. If provision and receipt are not confused with one another, such as in the case where the service user terminal 200 and the service provider server 300 do not provide and receive a plurality of personal information at the same time, the storage location parameter is unnecessary.

<<Modification: Making a Record without a Record Request>>

In the personal information provision process described above, the information distribution history management device 100 updates the record database 140 after receiving a receipt record request from the service provider server 300 (see steps S219 to S220 illustrated in FIG. 12). The information distribution history management device 100 may also update the record database 140 after transmitting the encrypted personal information in step S217, without receiving a receipt record request. A record of receipt can be made even in cases where there is no receipt record request, such as in the case of a network malfunction or a dishonest service provider server 300.

Similarly, for a record of provision, the information distribution history management device 100 may update the record database 140 (update the record time 142 (see step S215)) after transmitting the storage location in step S205, without receiving a provision record request.

The updating of the record database 140 without a record request indicated above is also similar for the process of distributing personal information between service providers.

<<Other Modifications>>

The present invention is not limited to the embodiment described above, and may be modified within a scope that does not deviate from the gist of the present invention. For example, although the information distribution history management device 100 stores databases such as the personal information database 130 and the record database 140, the databases may also be stored in an external device such as a database server.

In a record search (see FIGS. 15 and 16), instead of excluding the user 143 included in the search result, the user 143 may be replaced with different identification information such that the original user cannot be restored or inferred (anonymization, pseudonymization, or the like).

Moreover, the steps in the processes stated by the programs 121, 221, and 321 (see FIGS. 3, 7, and 8) may also be executed in an order different from the order illustrated in FIGS. 9 to 16, which furthermore includes cases where the steps are executed in parallel or individually, without necessarily being processed in a time series. For example, in FIGS. 11 and 12, the process of steps S214 to S215 and the process of steps S216 to S220 may also be interchanged or executed in parallel.

In the embodiment described above, in the case where personal information is provided from the service user terminal 200 to the service provider server 300 (see FIGS. 11 and 12), the service provider server 300 acting as the provision destination is recorded in the service provider 144 (see FIG. 5) and the service 145, and “N/A” is recorded in the provision destination 147 (see steps S204, S215, and S220 in FIGS. 11 and 12). Instead, the service provider server 300 may be considered to be the provision destination of the personal information and recorded in the provision destination 147, and “N/A” may be recorded in the service provider 144 and the service 145.

The foregoing describes several embodiments of the present invention, but these embodiments are merely illustrative examples and do not limit the technical scope of the present invention. The present invention may take a variety of other embodiments, and furthermore, various modifications such as simplifications and substitutions are possible without departing from the gist of the present invention. These embodiments and modifications thereof are included in the scope and gist of the invention described in this specification and the rest, and are also included in the scope of the invention as described in the claims and their equivalents.

<<Hardware Configuration>>

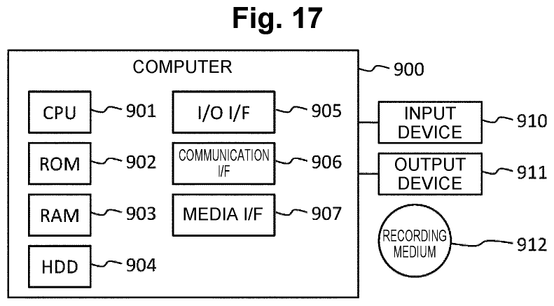

The information distribution history management device 100 according to the present embodiment is achieved by a computer 900 having a configuration like the one illustrated in FIG. 17, for example. FIG. 17 is a hardware configuration diagram illustrating an example of the computer 900 that achieves the functions of the information distribution history management device 100 according to the present embodiment. The computer 900 is provided with a CPU 901, read-only memory (ROM) 902, random access memory (RAM) 903, a hard disk 904 (designated HDD in FIG. 17), an input/output interface 905 (designated I/O I/F in FIG. 17), a communication interface 906, and a media interface 907.

The CPU 901 operates on the basis of a program stored in the ROM 902 or the hard disk 904, and performs the control by the control unit 110 in FIG. 3. The ROM 902 stores information such as a boot program executed by the CPU 901 when the computer 900 boots up and programs related to the hardware of the computer 900.

Through the input/output interface 905, the CPU 901 controls an input device 910 such as a mouse or a keyboard, as well as an output device 911 such as a display or a printer. Through the input/output interface 905, the CPU 901 acquires data from the input device 910 and also outputs generated data to the output device 911.

The hard disk 904 stores information such as a program executed by the CPU 901 and data used by the program. The communication interface 906 receives data from another device not illustrated (such as the service user terminal 200 or the service provider server 300 for example) through a communication network and outputs the data to the CPU 901, and also transmits data generated by the CPU 901 to another device through the communication network.

The media interface 907 reads programs or data stored in a recording medium 912, and outputs to the CPU 901 through the RAM 903. The CPU 901 loads a program from the recording medium 912 into the RAM 903 through the media interface 907, and executes the loaded program. The recording medium 912 is an optical recording medium such as a Digital Versatile Disc (DVD), a magneto-optical recording medium such as a magneto-optical (MO) disc, a magnetic recording medium, a conductor memory tape medium, a semiconductor memory, or the like.

For example, in the case where the computer 900 functions as the information distribution history management device 100 according to the present embodiment, the CPU 901 of the computer 900 achieves the functions of the information distribution history management device 100 by executing the program 121 (see FIG. 3) loaded into the RAM 903. The CPU 901 reads out and executes the program from the recording medium 912. Otherwise, the CPU 901 may load the program 121 from another device over a communication network or install the program 121 from the recording medium 912 onto the hard disk 904, and then execute the program 121.

<<Effects>>

Hereinafter, effects of the information distribution history management system 10 will be described.

The information distribution history management system 10 according to the present invention comprises a service user terminal 200, service provider servers 300A and 300B, and an information distribution history management device 100 connected by a network, wherein the service user terminal 200 requests the information distribution history management device 100 to make a record of provision in a case where the service user terminal 200 provides personal information related to a user of the service user terminal 200 to the service provider server 300A, the service provider server 300A requests the information distribution history management device 100 to make a record of receipt in a case where the service provider server 300A receives the provision of the personal information, the information distribution history management device 100 comprises a record creation unit 112 that stores a record of provision in response to a request from the service user terminal 200 and stores a record of receipt in response to a request from the service provider server 300A, the service provider server 300A requests the information distribution history management device 100 to make a record of provision in a case where the service provider server 300A provides the personal information to the service provider server 300B, the service provider server 300B requests the information distribution history management device 100 to make a record of receipt in a case where the service provider server 300B receives the provision of the personal information, and the record creation unit 112 stores a record of provision in response to a request from the service provider server 300A, and stores a record of receipt in response to a request from the service provider server 300B. The records include, in one case (the case where the provision destination 147 is “N/A”), identification information (user 143) of the user of the service user terminal 200 and identification information (service provider 144 and service 145) of the receiving service provider server 300A or identification information of a service provider of the receiving service provider server 300A, and in another case (the case where the provision destination 147 is not “N/A”), identification information (user 143) of the user of the service user terminal 200, identification information (service provider 144 and service 145) of the providing service provider server 300A or identification information of a service provider of the providing service provider server 300A, and identification information (provision destination 147) of the receiving service provider server 300B or identification information of a service provider of the receiving service provider server 300B. The information distribution history management device 100 further comprises a record search unit 114 that searches the records and returns a search result in response to a search request from the service user terminal 200 or the service provider servers 300A and 300B.

According to such an information distribution history management system 10, the information distribution history management device 100 can accumulate records of personal information provided and received from the service user terminal 200 to the service provider server 300A as well as records of personal information provided and received from the service provider server 300A to another service provider server 300B. In addition, the information distribution history management device 100 can search the records in response to a request from the service user terminal 200 or the service provider server 300A or 300B. With this arrangement, the user of the service user terminal 200 can know which service provider server 300 or service provider the user's own personal information has been distributed to.

In the case where a service provider server 300 that the user has no recollection of providing personal information to is retaining the user's own personal information, the user can trace back to the service provider server 300 or the service provider of the service provider server 300 that provided the personal information as well as the service provider server 300 or the service provider of the service provider server 300 that received the personal information, and thereby understand the route by which the user's own personal information was distributed to the service provider server 300 that the user has no recollection of.

Also, in the information distribution history management system 10, the records include a type of the personal information associated with the record, and if the record search unit 114 receives a record search request including identification information of the service provider server 300 or identification information of the service provider and transmitted by the service user terminal 200 or the service provider server 300, the record search unit 114 searches for records including the identification information of the service provider server 300 or the identification information of the service provider, and returns a search result with identification information (user 143) of a user removed from the search result.

According to such an information distribution history management system 10, the service user terminal 200 and the service provider server 300 can search for a type of personal information retained by the service provider server 300 or the service provider of the service provider server 300. The search result does not contain information about users, and the information distribution history management system 10 protects user privacy.

Also, in the information distribution history management system 10, the records include a type of the personal information associated with the record, and if the record search unit 114 receives a record search request including a type of the personal information and transmitted by the service user terminal 200 or the service provider server 300, the record search unit 114 searches for records including the type of the personal information, and returns a search result with identification information (user 143) of a user removed from the search result.

According to such an information distribution history management system 10, it is possible to search for a service provider server 300 or a service provider of a service provider server 300 retaining personal information that includes the type of personal information specified in the search request. The search result does not contain information about users, and the information distribution history management system 10 protects user privacy.

Also, in the information distribution history management system 10, if the record search unit 114 receives a record search request including identification information of the user and transmitted by the service provider server 300, the record search unit 114 searches for records of provision by the service provider server 300 or the service provider of the service provider server 300 including the identification information of the user, and acquires identification information of the receiving service provider server 300 and identification information of the service provider of the receiving service provider server 300 included in the search result as identification information of a distribution destination, and repeatedly searches for records including the identification information of the user and also including the identification information of the distribution destination as the identification information of the providing service provider server 300 or the identification information of the service provider of the providing service provider server, and adds the identification information of the receiving service provider server 300 and the identification information of the service provider of the receiving service provider server 300 included in the search result to the identification information of the distribution destination.

According to such an information distribution history management system 10, it is possible to search for the distribution destination of personal information (a service provider server 300 or a service provider of the service provider server 300 which was provided with, and which received, personal information) provided by the service provider server 300 or the service provider of the service provider server 300. The service provider server 300 or the service provider of the service provider server 300 can know the distribution destination to which the service provider server 300 or the service provider of the service provider server 300 itself provided personal information. In the case where personal information is provided under a contract, the service provider is able to check whether or not the contract is being honored.

Also, in the information distribution history management system 10, if the record search unit 114 receives a search request that does not include identification information of a user from the service user terminal 200 or the service provider server 300, the record search unit 114 returns a search result with identification information (user 143) of a user removed from the search result.

According to such an information distribution history management system 10, the search result does not contain information about a user, and searches can be performed while also protecting user privacy.

### Modification 1 of Embodiment

A process of removing personal information in response to a removal request from a service user in the information distribution history management system (also referred to as the system) according to Modification 1 of the present embodiment will be described.

The system of Modification 1 differs from the system 10 illustrated in FIG. 1 in the configurations of the information distribution history management device 100 (FIG. 3), the service user terminal 200 (FIG. 7), and the service provider server 300 (FIG. 8).

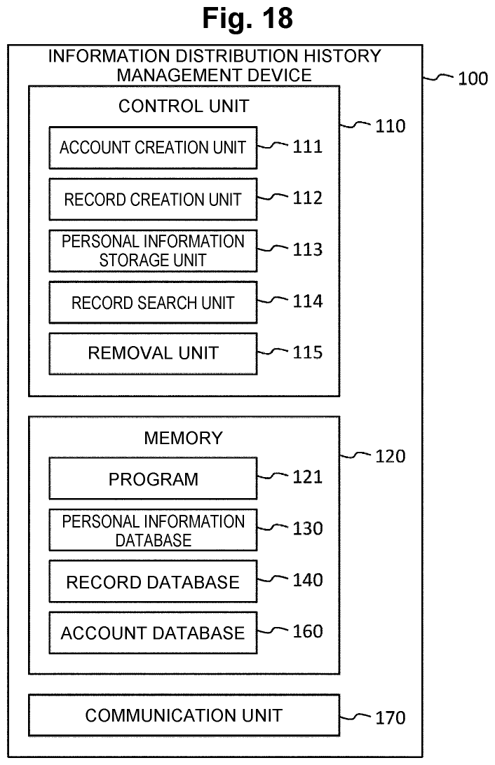

As illustrated in FIG. 18, in the information distribution history management device (also referred to as the management device) 100, the control unit 110 is further provided with a removal unit 115.

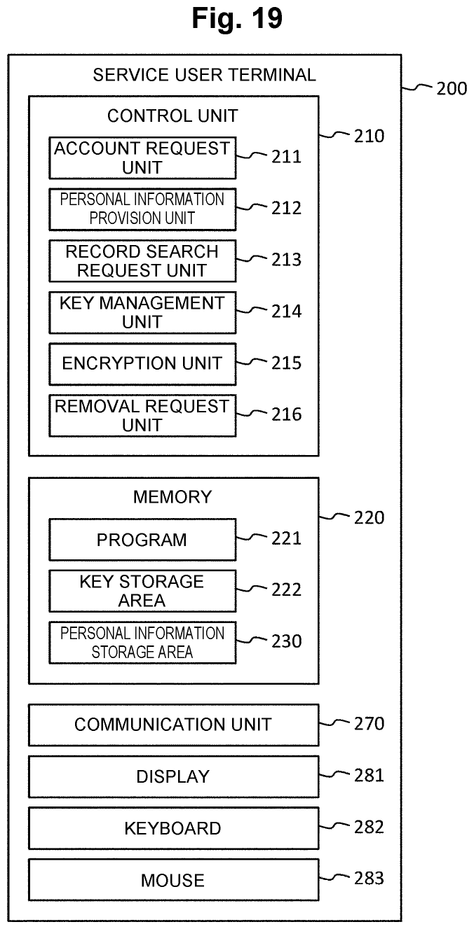

As illustrated in FIG. 19, in the service user terminal (also referred to as the terminal) 200, the control unit 210 is further provided with a removal request unit 216.

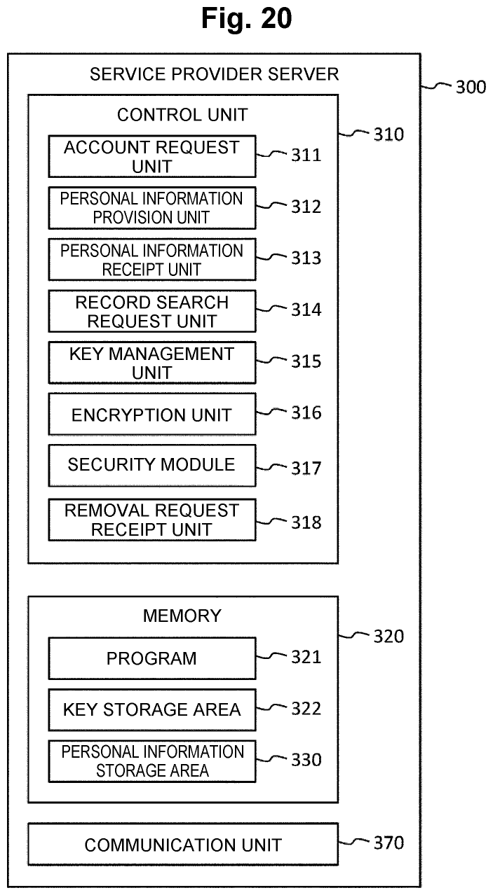

As illustrated in FIG. 20, in the service provider server (also referred to as the server) 300, the control unit 310 is further provided with a removal request receipt unit 318.

The removal request unit 216 of the terminal 200 illustrated in FIG. 19 transmits, to the management device 100, a removal request (first removal request) for removing the personal information of a service user held in a specific service provider server 300. The management device 100 receives the transmitted removal request. Note that the service user is also referred to as the user.

The removal unit 115 of the management device 100 illustrated in FIG. 18 receives the removal request from the removal request unit 216, and in response to the received removal request, transmits a request (second removal request) for removing the user's own personal information held in a specific service provider server 300 acting as the request target {for example, the server 300B (FIG. 1)}. However, the personal information is stored and held in the personal information storage area 330 of the memory 320 of the server 300 illustrated in FIG. 20.

The removal request receipt unit 318 of the server 300 illustrated in FIG. 20 receives the removal request (second removal request) from the removal unit 115, and removes the personal information indicated by the received removal request from among the personal information held in the personal information storage area 330. After the removal, the removal request receipt unit 318 transmits a personal information removal completion notification to the management device 100.

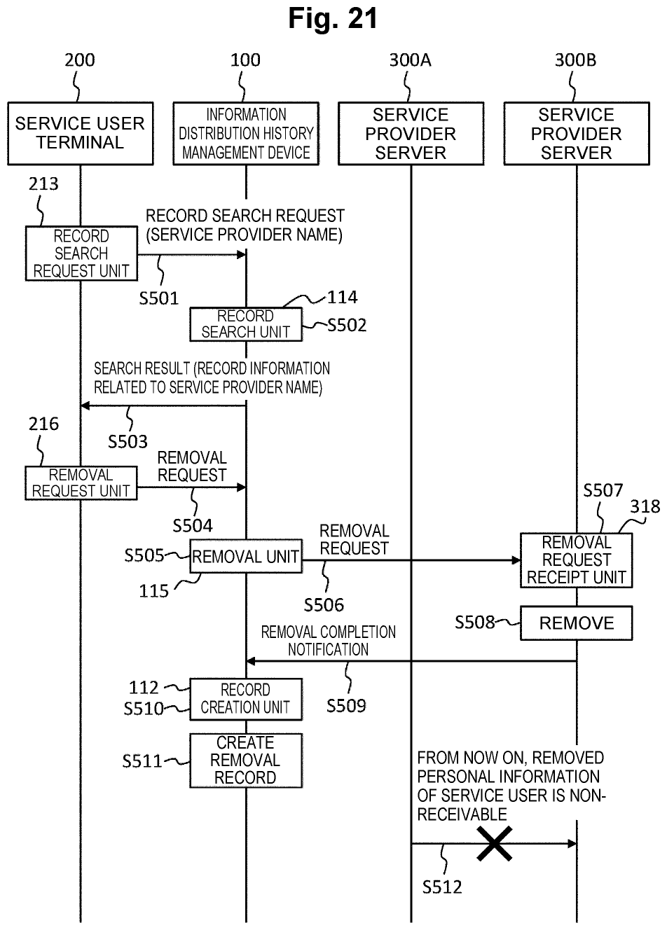

The operations for removing the personal information of a service user from the server 300 in response to a removal request from the service user in the system of Modification 1 with such a configuration will be described with reference to the sequence diagram illustrated in FIG. 21.

In step S501, the record search request unit 213 of the terminal 200 illustrated in FIG. 21 transmits a record search request to the management device 100. The record search request is a search request for a service provider name for example, and is received by the management device 100.

In step S502, the record search unit 114 of the management device 100 searches the record database 140 (FIG. 18) for record information according to the received search request for a service provider name.

In step S503, the record search unit 114 transmits a search request (record information related to the service provider name) to the terminal 200.

In step S504, the removal request unit 216 of the terminal 200 transmits, to the management device 100, a removal request (first removal request) regarding the personal information of the service user held in a specific service provider server 300 (for example, the ID of the server 300B is used).

In step S505, the removal unit 115 receives the transmitted removal request. After receiving, in step S506 the removal unit 115 transmits the received removal request to the server 300B acting as the request target. In other words, in step S506, the removal unit 115 transmits a request (second removal request) for removing the personal information of the user held in the server 300B. The personal information is held in the personal information storage area 330 of the memory 320 of the server 300B illustrated in FIG. 20.

In step S507, the removal request receipt unit 318 of the server 300B receives the removal request (second removal request) from the management device 100, and in step S508, removes the personal information indicated by the received removal request from the personal information storage area 330 in step S508. After the removal, in step S509, the removal request receipt unit 318 transmits, to the management device 100, a removal completion notification indicating that the personal information of the user has been removed.

In step S510, the record creation unit 112 of the management device 100 (see FIG. 18) receives the removal completion notification from the server 300B, and in step S511, creates a removal record containing an indication that the personal information of the user indicated in the removal completion notification was removed. The information of the created removal record is recorded in the record database 140.

After recording, in step S512, the personal information of the user associated with the removal record created by the server 300A is no longer receivable by the server 300B, as illustrated by the X symbol overlaid onto the arrow pointing from the server 300A to the server 300B. In other words, in step S508 above, the server 300B becomes unable to receive, from the server 300A, the personal information of the service user removed from the personal information storage area 330. This is because the personal information of the user removed from the server 300B (see step S508) is also removed from the server 300A, as described later.

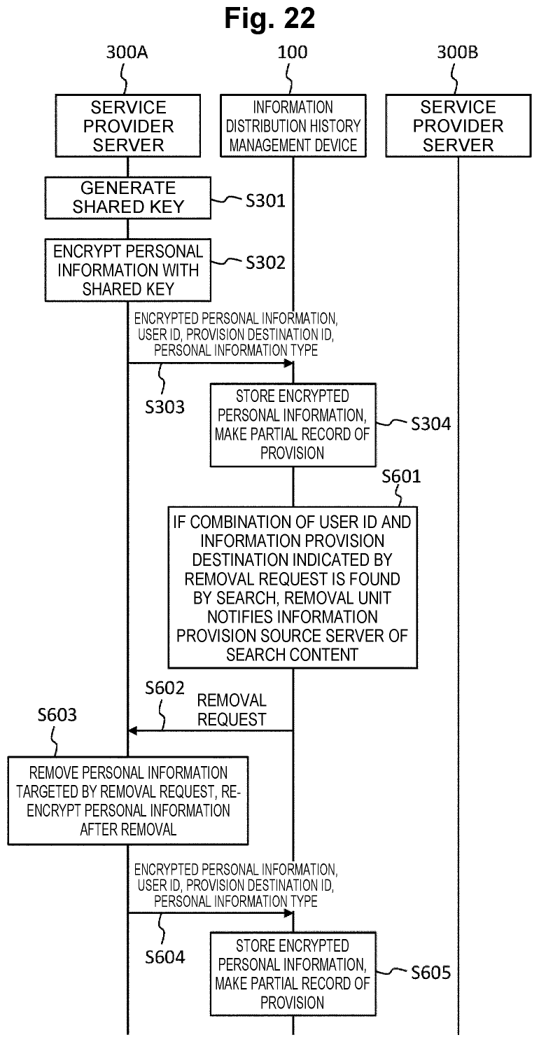

Such a “process of making the removed personal information of a user non-receivable” will be described with reference to the sequence diagram illustrated in FIG. 22.

However, steps S301 to S304 of the process illustrated in FIG. 22 are similar to the process described in FIG. 13. Namely, in step S301, the key management unit 315 (FIG. 20) of the server 300A generates a shared key for shared-key cryptography used to encrypt personal information. In step S302, the encryption unit 316 encrypts the personal information of the user with the shared key.

After encryption, in step S303, the personal information provision unit 312 (FIG. 20) of the server 300A transmits the personal information encrypted in step S302, the user ID, the provision destination ID, and the personal information type to the management device 100.

In step S304, the personal information storage unit 113 of the management device 100 (see FIG. 18) stores the received encrypted personal information (encrypted personal information, user ID, provision destination ID, personal information type) in the personal information database 130. Also, the record creation unit 112 makes a partial record of the provision in the record database 140 (see FIG. 5). The process of updating the personal information database 130 is similar to step S204 described above (see FIG. 11). However, in step S204, the provision destination 147 is “N/A”, but in step S304 is the server 300B specified as the provision destination by the server 300A.

Next, in step S601, when the combination of the user ID and the information provision destination (provision destination ID) indicated by the removal request is found in a search of the personal information database 130, the removal unit 115 (FIG. 18) of the management device 100 transmits a notification of the search content to the information provision source. In step S602, the notification is transmitted together with a removal request (third removal request) by the removal unit 115.

As an example, assume that the management device 100 has transmitted a removal request (second removal request) regarding the personal information of the user held in the server 300B in step S506 (FIG. 21) described above. At this point, assume that in step S601, the removal unit 115 (FIG. 18) of the management device 100 searches for the combination of the user ID and the server 300B acting as the information provision destination indicated by the removal request. In step S602, the removal unit 115 transmits a removal request (third removal request) regarding the personal information of the user indicated by the combination of the user ID and the server 300B obtained as the search content to the server 300A of the information provision source. The transmitted removal request is received by the server 300A.

In step S603, the removal request receipt unit 318 of the server 300A removes the personal information targeted by the removal request from the personal information storage area 330 (FIG. 20) according to the content of the received removal request. After removing the personal information targeted by the removal request, the encryption unit 316 re-encrypts the personal information of the user in the personal information storage area 330 with the shared key.

In step S604, the personal information provision unit 312 (FIG. 20) transmits the encrypted personal information, the user ID, the provision destination ID, and the personal information type to the management device 100. In step S605, the personal information storage unit 113 of the management device 100 stores the received encrypted personal information in the personal information database 130.

Through such a process, because the personal information of the service user that was removed from the server 300B acting as the information supply destination is also removed from the server 300A acting as the information supply source, the removed personal information of the service user is no longer receivable in the server 300B.

### Modification 2 of Embodiment

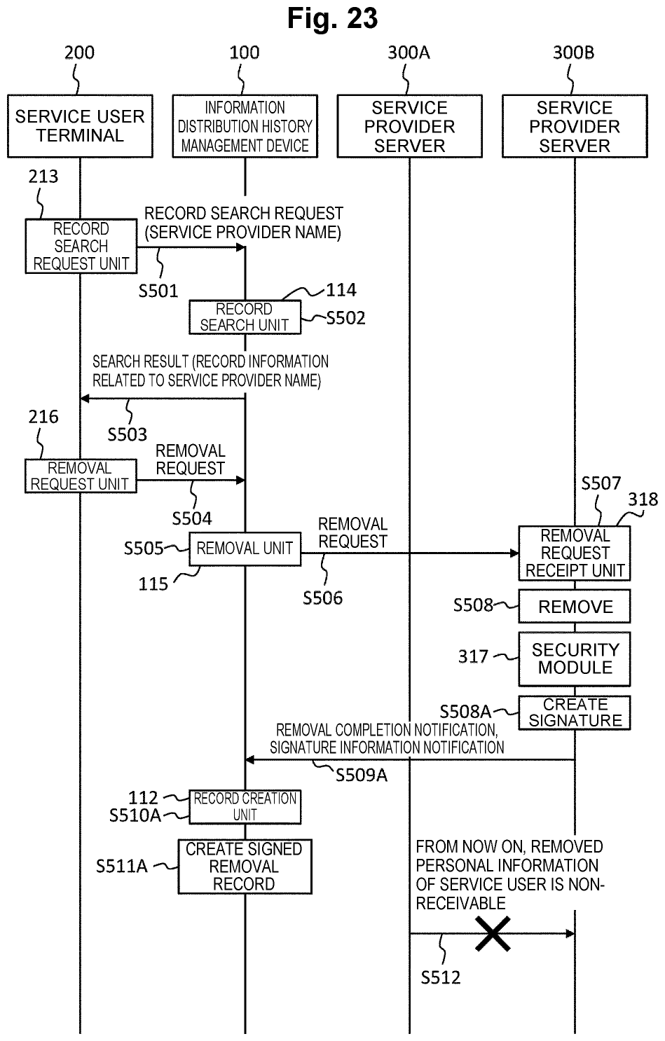

A process of removing personal information in response to a removal request from a service user in the information distribution history management system according to Modification 2 of the present embodiment will be described with reference to the sequence diagram illustrated in FIG. 23. However, the system according to Modification 2 is provided with the removal unit 115 (FIG. 18), the removal request unit 216 (FIG. 19), and the removal request receipt unit 318 (FIG. 20) of the system according to Modification 1 above.

In the sequence diagram in FIG. 23 illustrating a process by the system according to Modification 2, the processes of steps S508A, S509A, S510A, and S511A described later are different from the sequence diagram (FIG. 21) for the system according to Modification 1 described above.

Assume that in step S508 illustrated in FIG. 23, the removal request receipt unit 318 of the server 300B removes the personal information of a user from the personal information storage area 330 according to a removal request from the removal unit 115 (FIG. 18) of the management device 100. Next, in step S508A, the security module 317 (FIG. 20) signs a proof of the removal and generates signature information (creates a signature).

Next, in step S509A, the removal request receipt unit 318 notifies the management device 100 of a removal completion notification indicating that the personal information of the user was removed in step S508 above and the signature information created by the security module 317.

In step S510A, the record creation unit 112 (FIG. 18) of the management device 100 receives the removal completion notification and the signature information from the removal request receipt unit 318. Furthermore, in step S511A, the record creation unit 112 adds the signature information proving the removal to the removal record indicating the removal of the personal information of the user indicated by the received removal completion notification, and creates the information of a signed removal record. The information of the created signed removal record is recorded in the record database 140.

In this way, the management device 100 can hold in the record database 140 the information of a signed removal record obtained by adding signature information proving the removal to the removal record indicating that the personal information of the user was removed in the server 300B. Consequently, the management device 100 can prove that the server 300B has removed the personal information of the user indicated in the removal request from the terminal 200, and thereby manage the personal information of the user with heightened security.

### Modification 3 of Embodiment

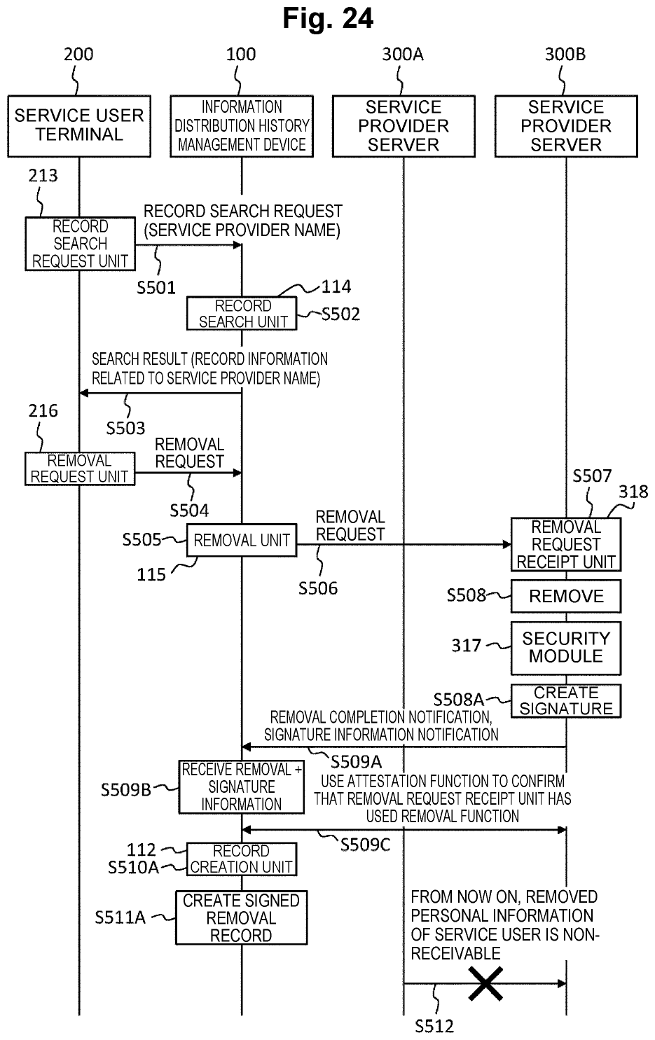

A process of removing personal information in response to a removal request from a service user in the information distribution history management system according to Modification 3 of the present embodiment will be described with reference to the sequence diagram illustrated in FIG. 24. However, the system according to Modification 3 is provided with the removal unit 115 (FIG. 18), the removal request unit 216 (FIG. 19), and the removal request receipt unit 318 (FIG. 20) of the system according to Modification 1 above.

In the sequence diagram in FIG. 24 illustrating a process by the system according to Modification 3, the processes of steps S509B and S509C described later are different from the sequence diagram (FIG. 23) for the system according to Modification 2 described above.

In step S509A illustrated in FIG. 24, assume that the removal request receipt unit 318 of the server 300B notifies the management device 100 of a removal completion notification indicating that the personal information of the user was removed and the signature information created by the security module 317, as described above.

In step S509B, the removal unit 115 of the management device 100 receives the notification, and in step S509C, the removal unit 115 uses the attestation function described earlier to confirm that the removal request receipt unit 318 has used the removal function. Note that the attestation function is a function of the security module 317 that replies to a query about whether or not the handling of personal information is enforced according to a security policy.

In the case of confirming that the above signature has been created, the record creation unit 112 receives the removal completion notification and the signature information in step S510A, and in step S511A, the record creation unit 112 creates the information of the signed removal record by adding the signature information proving the removal to the removal record indicating the removal of the personal information of the user indicated by the removal completion notification.

The creation process is not executed in the case where it is not confirmed that the above signature has been created. In this case, the flow returns to step S506 and is executed from the removal request.

In this way, when a removal completion notification and signature information are transmitted from the server 300B to the management device 100, the management device 100 confirms that the security module 317 has signed a proof of the removal of the personal information, and retains the information of the signed removal record after confirming the signature. Consequently, the management device 100 can confirm that the server 300B has removed the personal information of the user indicated in the removal request from the terminal 200, and thereby manage the personal information of the user with security heightened further.

### REFERENCE SIGNS LIST

10 information distribution history management
system
100 information distribution history management
device
110 control unit
111 account creation unit
112 record creation unit
113 personal information storage unit
114 record search unit
115 removal unit
120 memory
121 program
130 personal information database
140 record database
160 account database
200 service user terminal
216 removal request unit
300 service provider server
318 removal request receipt unit

1. An information distribution history management system comprising a service user terminal, a service provider server, and an information distribution history management device connected by a network, wherein
the service user terminal, including one or more processors, is configured to request the information distribution history management device to make a record of provision in a case where the service user terminal provides personal information related to a user of the service user terminal to the service provider server,
the service provider server, including one or more processors, is configured to request the information distribution history management device to make a record of receipt in a case where the service provider server receives the provision of the personal information,
the information distribution history management device comprises a record creation unit, including one or more processors, configured to store a record of provision in response to a request from the service user terminal and store a record of receipt in response to a request from the service provider server,
the service provider server is configured to request the information distribution history management device to make a record of provision in a case where the service provider server provides the personal information to another service provider server,
the other service provider server, including one or more processors, is configured to request the information distribution history management device to make a record of receipt in a case where the other service provider server receives the provision of the personal information,
the record creation unit is configured to store a record of provision in response to a request from the service provider server, and store a record of receipt in response to a request from the other service provider server,
the records including
in one case, identification information of the user of the service user terminal and identification information of the receiving service provider server or identification information of a service provider of the receiving service provider server, and
in another case, identification information of the user of the service user terminal, identification information of the providing service provider server or identification information of a service provider of the providing service provider server, and identification information of the receiving other service provider server or identification information of a service provider of the receiving other service provider server, and
the information distribution history management device further comprises a record search unit, including one or more processors, configured to search the records and return a search result in response to a search request from the service user terminal or the service provider server.

2. The information distribution history management system according to claim 1, wherein
the records include a type of the personal information associated with the record, and
if the record search unit receives a record search request including identification information of the service provider server or identification information of the service provider and transmitted by the service user terminal or the service provider server, the record search unit is configured to search for records including the identification information of the service provider server or the identification information of the service provider, and return a search result with identification information of a user removed from the search result.

3. The information distribution history management system according to claim 1, wherein
the records include a type of the personal information associated with the record, and
if the record search unit receives a record search request including a type of the personal information and transmitted by the service user terminal or the service provider server, the record search unit is configured to search for records including the type of the personal information, and return a search result with identification information of a user removed from the search result.

4. The information distribution history management system according to claim 1, wherein
if the record search unit receives a record search request including identification information of the user and transmitted by the service provider server, the record search unit is configured to:
search for records of provision by the service provider server or the service provider of the service provider server including the identification information of the user, and acquire identification information of the receiving service provider server and identification information of the service provider of the receiving service provider server included in the search result as identification information of a distribution destination, and
repeatedly search for records including the identification information of the user and also including the identification information of the distribution destination as the identification information of the providing service provider server or the identification information of the service provider of the providing service provider server, and add the identification information of the receiving service provider server and the identification information of the service provider of the receiving service provider server included in the search result to the identification information of the distribution destination.

5. The information distribution history management system according to claim 1, wherein
if the record search unit receives a search request that does not include identification information of a user from the service user terminal or the service provider server, the record search unit is configured to return a search result with identification information of a user removed from the search result.

6. The information distribution history management system according to claim 1, wherein
the service user terminal further comprises a removal request unit, including one or more processors, configured to generate a first removal request for removing personal information about a service user held by a specific service provider server,
the information distribution history management device further comprises a removal unit, including one or more processors, configured to generate, in response to the first removal request received from the service user terminal, a second removal request for removing personal information about a user held in the requested specific service provider server,
the specific service provider server further comprises a removal request receipt unit, including one or more processors, configured to remove personal information from the service provider server in accordance with the second removal request received from the information distribution history management device, and generate a removal completion notification indicating completion of the removal, and
after the information distribution history management device receives the removal completion notification, the record creation unit is configured to create and store a removal record indicating that the personal information about the user indicated by the removal completion notification has been removed.

7. The information distribution history management system according to claim 6, wherein
the service provider server further comprises a security module, including one or more processors, configured to, after the removal request receipt unit removes the personal information from the service provider server in accordance with the second removal request, sign a proof of the removal to create signature information, and
after the information distribution history management device receives the removal completion notification and the signature information, the record creation unit is configured to create and store a signed removal record obtained by adding the signature information to a removal record indicating that the personal information about the user indicated by the received removal completion notification has been removed.

8. The information distribution history management system according to claim 7, wherein
after the information distribution history management device receives the removal completion notification and the signature information, the removal unit is configured to uses an attestation function to confirm that the signature information has been created, the attestation function being a function that responds to indicate that the security module is enforcing a security policy, and
if confirmation is obtained, the record creation unit is configured to create and store the signed removal record with the signature information added to the removal record indicating that the personal information about the user indicated by the removal completion notification has been removed.

9. The information distribution history management system according to claim 6, wherein
in a case where a combination of a stored user ID (IDentifier) acting as the identification information of a user of the service user terminal and a provision destination ID acting as identification information of the service provider server of the information provision destination indicated by the second removal request is found in a search of a personal information database, the removal unit is configured to generate a third removal request regarding the personal information of the user indicated by the combination of the user ID and the provision destination ID obtained as the search content, and
the removal request receipt unit of the service provider server of the information provision source that receives the third removal request is configured to remove the personal information targeted by the removal request according to the content of the third removal request, re-encrypt the personal information of the user after the removal, and notify the information distribution history management device of the encrypted personal information.

10. An information distribution history management method of an information distribution history management system including a service user terminal, a service provider server, and an information distribution history management device connected by a network, the information distribution history management method comprising:
by the service user terminal, requesting the information distribution history management device to make a record of provision in a case where the service user terminal provides personal information related to a user of the service user terminal to the service provider server;
by the service provider server, requesting the information distribution history management device to make a record of receipt in a case where the service provider server receives the provision of the personal information;
by the information distribution history management device, storing a record of provision in response to a request from the service user terminal and storing a record of receipt in response to a request from the service provider server;
by the service provider server, requesting the information distribution history management device to make a record of provision in a case where the service provider server provides the personal information to another service provider server;
by the other service provider server, requesting the information distribution history management device to make a record of receipt in a case where the service provider server receives the provision of the personal information;
by the information distribution history management device, storing a record of provision in response to a request from the service provider server and storing a record of receipt in response to a request from the other service provider server,
the records including
in one case, identification information of the user of the service user terminal and identification information of the receiving service provider server or identification information of a service provider of the receiving service provider server, and
in another case, identification information of the user of the service user terminal, identification information of the providing service provider server or identification information of a service provider of the providing service provider server, and identification information of the receiving other service provider server or identification information of a service provider of the receiving other service provider server, and
by the information distribution history management device, searching the records and returning a search result in response to a search request from the service user terminal or the service provider server.

11. An information distribution history management device of an information distribution history management system including a service user terminal, a service provider server, and the information distribution history management device connected by a network, the information distribution history management device comprising:
a record creation unit, including one or more processors, configured to:
store a record of provision in response to a request from the service user terminal that provides personal information related to a user of the service user terminal to the service provider server,
store a record of receipt in response to a request from the service provider server that receives the provision of the personal information,
store a record of provision in response to a request from the service provider server that provides the personal information to another service provider server, and
store a record of receipt in response to a request from the other service provider server that receives the provision of the personal information,
the records including
in one case, identification information of the user of the service user terminal and identification information of the receiving service provider server or identification information of a service provider of the receiving service provider server, and
in another case, identification information of the user of the service user terminal, identification information of the providing service provider server or identification information of a service provider of the providing service provider server, and identification information of the receiving other service provider server or identification information of a service provider of the receiving other service provider server, and
the information distribution history management device further comprises a record search unit, including one or more processors, configured to search the records and return a search result in response to a search request from the service user terminal or the service provider server.

12. A non-transitory computer-readable storage medium storing a program causing a computer to function as the information distribution history management device according to claim 11.

13. The information distribution history management method according to claim 10, wherein
the records include a type of the personal information associated with the record, and
the information distribution history management method further comprises:
by the information distribution history management device, in response to receiving a record search request including identification information of the service provider server or identification information of the service provider and transmitted by the service user terminal or the service provider server, searching for records including the identification information of the service provider server or the identification information of the service provider, and returning a search result with identification information of a user removed from the search result.

14. The information distribution history management method according to claim 10, wherein
the records include a type of the personal information associated with the record, and
the information distribution history management method further comprises:
by the information distribution history management device, in response to receiving a record search request including a type of the personal information and transmitted by the service user terminal or the service provider server, searching for records including the type of the personal information, and returning a search result with identification information of a user removed from the search result.

15. The information distribution history management method according to claim 10, further comprising, by the information distribution history management device:
in response to receiving a record search request including identification information of the user and transmitted by the service provider server, performing
searching for records of provision by the service provider server or the service provider of the service provider server including the identification information of the user, and acquiring identification information of the receiving service provider server and identification information of the service provider of the receiving service provider server included in the search result as identification information of a distribution destination, and
repeatedly searching for records including the identification information of the user and also including the identification information of the distribution destination as the identification information of the providing service provider server or the identification information of the service provider of the providing service provider server, and adding the identification information of the receiving service provider server and the identification information of the service provider of the receiving service provider server included in the search result to the identification information of the distribution destination.

16. The information distribution history management method according to claim 10, further comprising, by the information distribution history management device:
in response to receiving a search request that does not include identification information of a user from the service user terminal or the service provider server, returning a search result with identification information of a user removed from the search result.

17. The information distribution history management method according to claim 10, further comprising:
by the service user terminal, generating a first removal request for removing personal information about a service user held by a specific service provider server,
by the information distribution history management device, in response to the first removal request received from the service user terminal, generating a second removal request for removing personal information about a user held in the requested specific service provider server,
by the specific service provider server, removing personal information from the service provider server in accordance with the second removal request received from the information distribution history management device, and generating a removal completion notification indicating completion of the removal, and
by the information distribution history management device, after receiving the removal completion notification, creating and storing a removal record indicating that the personal information about the user indicated by the removal completion notification has been removed.

18. The information distribution history management method according to claim 17, further comprising:
by the service provider server, after removing the personal information from the service provider server in accordance with the second removal request, signing a proof of the removal to create signature information, and
by the information distribution history management device, after receiving the removal completion notification and the signature information, creating and storing a signed removal record obtained by adding the signature information to a removal record indicating that the personal information about the user indicated by the received removal completion notification has been removed.

19. The information distribution history management method according to claim 18, further comprising, by the information distribution history management device:
after receiving the removal completion notification and the signature information, using an attestation function to confirm that the signature information has been created, the attestation function being a function that responds to indicate that the security module is enforcing a security policy, and
in response to a confirmation is obtained, creating and storing the signed removal record with the signature information added to the removal record indicating that the personal information about the user indicated by the removal completion notification has been removed.

20. The information distribution history management method according to claim 17, further comprising:
by the information distribution history management device, in a case where a combination of a stored user ID (IDentifier) acting as the identification information of a user of the service user terminal and a provision destination ID acting as identification information of the service provider server of the information provision destination indicated by the second removal request is found in a search of a personal information database, generating a third removal request regarding the personal information of the user indicated by the combination of the user ID and the provision destination ID obtained as the search content, and
by the service provider server of the information provision source that receives the third removal request, removing the personal information targeted by the removal request according to the content of the third removal request, re-encrypting the personal information of the user after the removal, and notifying the information distribution history management device of the encrypted personal information.
